(19) United States
(12) Patent Application Publication
(10) Pub. No.: US 2021/0219061 A1
(43) Pub. Date: Jul. 15, 2021

(54) BONE CONDUCTION SPEAKER AND COMPOUND VIBRATION DEVICE THEREOF

(71) Applicant: SHENZHEN VOXTECH CO., LTD., Shenzhen (CN)

(72) Inventors: Xin QI, Shenzhen (CN); Fengyun LIAO, Shenzhen (CN); Jinbo ZHENG, Shenzhen (CN); Qian CHEN, Shenzhen (CN); Hao CHEN, Shenzhen (CN); Lei ZHANG, Shenzhen (CN); Junjiang FU, Shenzhen (CN); Bingyan YAN, Shenzhen (CN)

(73) Assignee: SHENZHEN VOXTECH CO., LTD., Shenzhen (CN)

(21) Appl. No.: 17/218,494

(22) Filed: Mar. 31, 2021

Related U.S. Application Data
(63) Continuation-in-part of application No. 17/170,817, filed on Feb. 8, 2021.
Application No. 17/170,817 is a continuation of application No. 17/161,717, filed on Jan. 29, 2021.
Application No. 17/161,717 is a continuation-in-part of application No. 16/159,070, filed on Oct. 12, 2018, now Pat. No. 10,911,876.
Application No. 16/159,070 is a continuation of application No. 15/197,050, filed on Jun. 29, 2016, now Pat. No. 10,117,026.
Application No. 15/197,050 is a continuation of application No. 14/513,371, filed on Oct. 14, 2014, now Pat. No. 9,402,116.
Application No. 14/513,371 is a continuation of application No. 13/719,754, filed on Dec. 19, 2012, now Pat. No. 8,891,792.
Application No. 17/161,717 is a continuation-in-part of application No. 16/833,839, filed on Mar. 30, 2020.
Application No. 16/833,839 is a continuation of application No. 15/752,452, filed on Feb. 13, 2018, now Pat. No. 10,609,496.
Application No. 15/752,452 is a continuation-in-part of application No. 17/170,947, filed on Feb. 9, 2021.
Application No. 17/170,947 is a continuation of application No. PCT/CN2020/084161, filed on Apr. 10, 2020.

(30) Foreign Application Priority Data
Dec. 23, 2011 (CN) 201110438083.9

(51) Int. Cl. H04R 9/06; H04R 9/02; H04R 1/00; H04R 31/00; H04R 1/10

(52) U.S. Cl. CPC H04R 9/063; H04R 9/02; H04R 9/025; H04R 1/00; H04R 25/606; H04R 1/10; H04R 9/066; H04R 2460/13; H04R 31/00

(57) ABSTRACT

The present disclosure relates to a bone conduction speaker and its compound vibration device. The compound vibration device comprises a vibration conductive plate and a vibration board, the vibration conductive plate is set to be the first torus, where at least two first rods inside it converge to its center; the vibration board is set as the second torus, where at least two second rods inside it converge to its center. The vibration conductive plate is fixed with the vibration board; the first torus is fixed on a magnetic system, and the second torus comprises a fixed voice coil, which is driven by the magnetic system. The bone conduction speaker in the present disclosure and its compound vibration device adopt the fixed vibration conductive plate and vibration board, making the technique simpler with a lower cost; because the two adjustable parts in the compound vibration device can adjust both low frequency and high frequency area, the frequency response obtained is flatter and the sound is broader.

### CROSS-REFERENCE TO RELATED APPLICATIONS

This application is a continuation-in-part application of U.S. patent application Ser. No. 17/170,817, filed on Feb. 8, 2021, which is a continuation of U.S. patent application Ser. No. 17/161,717, filed on Jan. 29, 2021, which is a continuation-in-part application of U.S. patent application Ser. No. 16/159,070 (issued as U.S. Pat. No. 10,911,876), filed on Oct. 12, 2018, which is a continuation of U.S. patent application Ser. No. 15/197,050 (issued as U.S. Pat. No. 10,117,026), filed on Jun. 29, 2016, which is a continuation of U.S. patent application Ser. No. 14/513,371 (issued as U.S. Pat. No. 9,402,116), filed on Oct. 14, 2014, which is a continuation of U.S. patent application Ser. No. 13/719,754 (issued as U.S. Pat. No. 8,891,792), filed on Dec. 19, 2012, which claims priority to Chinese Patent Application No. 201110438083.9, filed on Dec. 23, 2011; U.S. patent application Ser. No. 17/161,717, filed on Jan. 29, 2021 is also a continuation-in-part application of U.S. patent application Ser. No. 16/833,839, filed on Mar. 30, 2020, which is a continuation of U.S. application Ser. No. 15/752,452 (issued as U.S. Pat. No. 10,609,496), filed on Feb. 13, 2018, which is a national stage entry under 35 U.S.C. § 371 of International Application No. PCT/CN2015/086907, filed on Aug. 13, 2015; this application is also a continuation-in-part of U.S. patent application Ser. No. 17/170,947, filed on Feb. 9, 2021, which is a continuation of International Application No. PCT/CN2020/084161, filed on Apr. 10, 2020, and claims priority to Chinese Patent Application No. 201910888067.6, filed on Sep. 19, 2019, Chinese Patent Application No. 201910888762.2, filed on Sep. 19, 2019, and Chinese Patent Application No. 201910364346.2, filed on Apr. 30, 2019. Each of the above-referenced applications is hereby incorporated by reference.

### TECHNICAL FIELD

The present disclosure relates to improvements on a bone conduction speaker and its components, in detail, relates to a bone conduction speaker and its compound vibration device, while the frequency response of the bone conduction speaker has been improved by the compound vibration device, which is composed of vibration boards and vibration conductive plates.

### BACKGROUND

Based on the current technology, the principle that we can hear sounds is that the vibration transferred through the air in our external acoustic meatus, reaches to the ear drum, and the vibration in the ear drum drives our auditory nerves, makes us feel the acoustic vibrations. The current bone conduction speakers are transferring vibrations through our skin, subcutaneous tissues and bones to our auditory nerves, making us hear the sounds.

When the current bone conduction speakers are working, with the vibration of the vibration board, the shell body, fixing the vibration board with some fixers, will also vibrate together with it, thus, when the shell body is touching our post auricles, cheeks, forehead or other parts, the vibrations will be transferred through bones, making us hear the sounds clearly.

However, the frequency response curves generated by the bone conduction speakers with current vibration devices are shown as the two solid lines in FIG. 4. In ideal conditions, the frequency response curve of a speaker is expected to be a straight line, and the top plain area of the curve is expected to be wider, thus the quality of the tone will be better, and easier to be perceived by our ears. However, the current bone conduction speakers, with their frequency response curves shown as FIG. 4, have overtopped resonance peaks either in low frequency area or high frequency area, which has limited its tone quality a lot. Thus, it is very hard to improve the tone quality of current bone conduction speakers containing current vibration devices. The current technology needs to be improved and developed.

### SUMMARY

The purpose of the present disclosure is providing a bone conduction speaker and its compound vibration device, to improve the vibration parts in current bone conduction speakers, using a compound vibration device composed of a vibration board and a vibration conductive plate to improve the frequency response of the bone conduction speaker, making it flatter, thus providing a wider range of acoustic sound.

The technical proposal of present disclosure is listed as below:

A compound vibration device in bone conduction speaker contains a vibration conductive plate and a vibration board, the vibration conductive plate is set as the first torus, where at least two first rods in it converge to its center. The vibration board is set as the second torus, where at least two second rods in it converge to its center. The vibration conductive plate is fixed with the vibration board. The first torus is fixed on a magnetic system, and the second torus contains a fixed voice coil, which is driven by the magnetic system.

In the compound vibration device, the magnetic system contains a baseboard, and an annular magnet is set on the board, together with another inner magnet, which is concentrically disposed inside this annular magnet, as well as an inner magnetic conductive plate set on the inner magnet, and the annular magnetic conductive plate set on the annular magnet. A grommet is set on the annular magnetic conductive plate to fix the first torus. The voice coil is set between the inner magnetic conductive plate and the annular magnetic plate.

In the compound vibration device, the number of the first rods and the second rods are both set to be three.

In the compound vibration device, the first rods and the second rods are both straight rods.

In the compound vibration device, there is an indentation at the center of the vibration board, which adapts to the vibration conductive plate.

In the compound vibration device, the vibration conductive plate rods are staggered with the vibration board rods.

In the compound vibration device, the staggered angles between rods are set to be 60 degrees.

In the compound vibration device, the vibration conductive plate is made of stainless steel, with a thickness of 0.1-0.2 mm, and, the width of the first rods in the vibration conductive plate is 0.5-1.0 mm; the width of the second rods in the vibration board is 1.6-2.6 mm, with a thickness of 0.8-1.2 mm.

In the compound vibration device, the number of the vibration conductive plate and the vibration board is set to be more than one. They are fixed together through their centers and/or torus.

A bone conduction speaker comprises a compound vibration device which adopts any methods stated above.

The bone conduction speaker and its compound vibration device as mentioned in the present disclosure, adopting the fixed vibration boards and vibration conductive plates, make the technique simpler with a lower cost. Also, because the two parts in the compound vibration device can adjust low frequency and high frequency areas, the achieved frequency response is flatter and wider, the possible problems like abrupt frequency responses or feeble sound caused by single vibration device will be avoided.

### BRIEF DESCRIPTION OF THE DRAWINGS

FIG. 1 illustrates a longitudinal section view of the bone conduction speaker in the present disclosure;

FIG. 2 illustrates a perspective view of the vibration parts in the bone conduction speaker in the present disclosure;

FIG. 3 illustrates an exploded perspective view of the bone conduction speaker in the present disclosure;

FIG. 4 illustrates a frequency response curves of the bone conduction speakers of vibration device in the prior art;

FIG. 5 illustrates a frequency response curves of the bone conduction speakers of the vibration device in the present disclosure;

FIG. 6 illustrates a perspective view of the bone conduction speaker in the present disclosure;

FIG. 7 illustrates a structure of the bone conduction speaker and the compound vibration device according to some embodiments of the present disclosure;

FIG. 8-A illustrates an equivalent vibration model of the vibration portion of the bone conduction speaker according to some embodiments of the present disclosure;

FIG. 8-B illustrates a vibration response curve of the bone conduction speaker according to one specific embodiment of the present disclosure;

FIG. 8-C illustrates a vibration response curve of the bone conduction speaker according to one specific embodiment of the present disclosure;

FIG. 9-A illustrates a structure of the vibration generation portion of the bone conduction speaker according to one specific embodiment of the present disclosure;

FIG. 9-B illustrates a vibration response curve of the bone conduction speaker according to one specific embodiment of the present disclosure;

FIG. 9-C illustrates a sound leakage curve of the bone conduction speaker according to one specific embodiment of the present disclosure;

FIG. 10 illustrates a structure of the vibration generation portion of the bone conduction speaker according to one specific embodiment of the present disclosure;

FIG. 11-A illustrates an application scenario of the bone conduction speaker according to one specific embodiment of the present disclosure;

FIG. 11-B illustrates a vibration response curve of the bone conduction speaker according to one specific embodiment of the present disclosure;

FIG. 12 illustrates a structure of the vibration generation portion of the bone conduction speaker according to one specific embodiment of the present disclosure;

FIG. 13 illustrates a structure of the vibration generation portion of the bone conduction speaker according to one specific embodiment of the present disclosure;

FIG. 14 is a schematic diagram illustrating a longitudinal sectional view of an exemplary bone conduction speaker according to some embodiments of the present disclosure;

FIG. 15 is a schematic diagram illustrating a longitudinal sectional view of an exemplary magnetic system according to some embodiments of the present disclosure;

FIG. 16 is a schematic diagram illustrating a longitudinal sectional view of an exemplary magnetic system according to some embodiments of the present disclosure;

FIG. 17 is a schematic diagram illustrating a longitudinal sectional view of an exemplary magnetic system according to some embodiments of the present disclosure;

FIG. 18 is a schematic diagram illustrating a longitudinal sectional view of an exemplary magnetic system according to some embodiments of the present disclosure; and

FIG. 19 is a schematic diagram illustrating a longitudinal sectional view of an exemplary magnetic system according to some embodiments of the present disclosure.

### DETAILED DESCRIPTION

A detailed description of the implements of the present disclosure is stated here, together with attached figures.

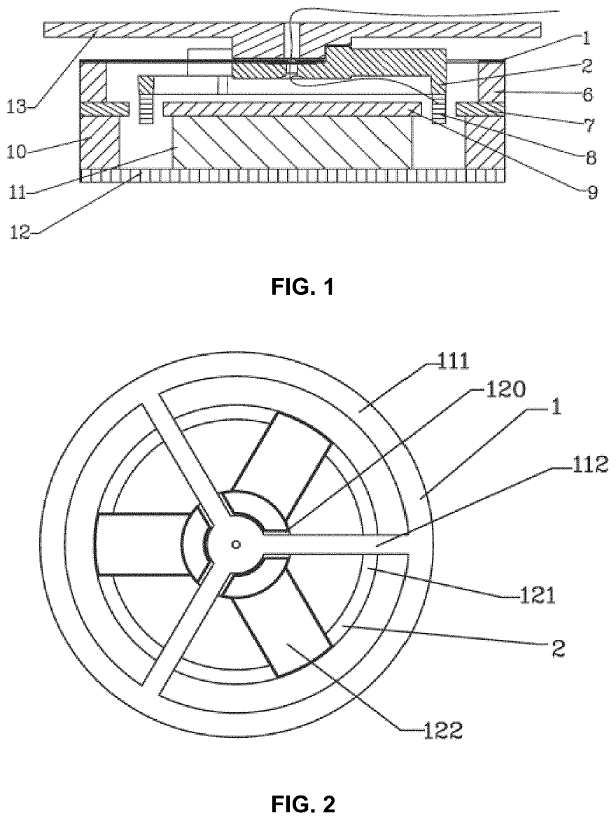

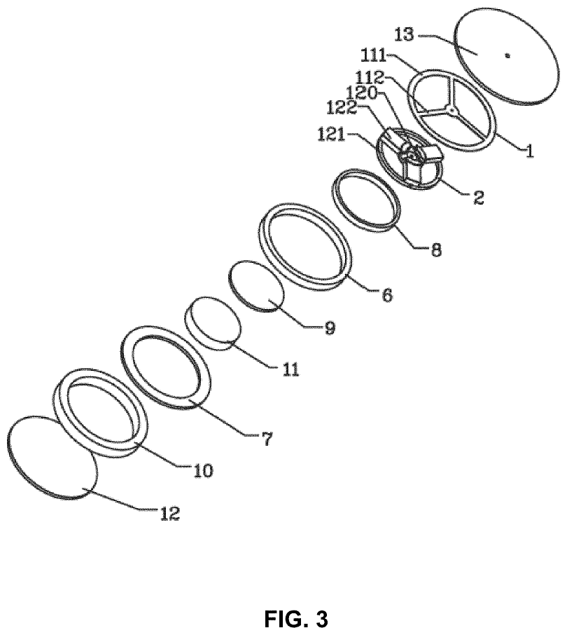

As shown in FIG. 1 and FIG. 3, the compound vibration device in the present disclosure of bone conduction speaker, comprises: the compound vibration parts composed of vibration conductive plate 1 and vibration board 2, the vibration conductive plate 1 is set as the first torus 111 and three first rods 112 in the first torus converging to the center of the torus, the converging center is fixed with the center of the vibration board 2. The center of the vibration board 2 is an indentation 120, which matches the converging center and the first rods. The vibration board 2 contains a second torus 121, which has a smaller radius than the vibration conductive plate 1, as well as three second rods 122, which is thicker and wider than the first rods 112. The first rods 112 and the second rods 122 are staggered, present but not limited to an angle of 60 degrees, as shown in FIG. 2. A better solution is, both the first and second rods are all straight rods.

Obviously the number of the first and second rods can be more than two, for example, if there are two rods, they can be set in a symmetrical position; however, the most economic design is working with three rods. Not limited to this rods setting mode, the setting of rods in the present disclosure can also be a spoke structure with four, five or more rods.

The vibration conductive plate 1 is very thin and can be more elastic, which is stuck at the center of the indentation 120 of the vibration board 2. Below the second torus 121 spliced in vibration board 2 is a voice coil 8. The compound vibration device in the present disclosure also comprises a bottom plate 12, where an annular magnet 10 is set, and an inner magnet 11 is set in the annular magnet 10 concentrically. An inner magnet conduction plate 9 is set on the top of the inner magnet 11, while annular magnet conduction plate 7 is set on the annular magnet 10, a grommet 6 is fixed above the annular magnet conduction plate 7, the first torus 111 of the vibration conductive plate 1 is fixed with the grommet 6. The whole compound vibration device is connected to the outside through a panel 13, the panel 13 is fixed with the vibration conductive plate 1 on its converging center, stuck and fixed at the center of both vibration conductive plate 1 and vibration board 2.

It should be noted that, both the vibration conductive plate and the vibration board can be set more than one, fixed with each other through either the center or staggered with both center and edge, forming a multilayer vibration structure, corresponding to different frequency resonance ranges, thus achieve a high tone quality earphone vibration unit with a gamut and full frequency range, despite of the higher cost.

The bone conduction speaker contains a magnet system, composed of the annular magnet conductive plate 7, annular magnet 10, bottom plate 12, inner magnet 11 and inner magnet conductive plate 9, because the changes of audio-frequency current in the voice coil 8 cause changes of magnet field, which makes the voice coil 8 vibrate. The compound vibration device is connected to the magnet system through grommet 6. The bone conduction speaker connects with the outside through the panel 13, being able to transfer vibrations to human bones.

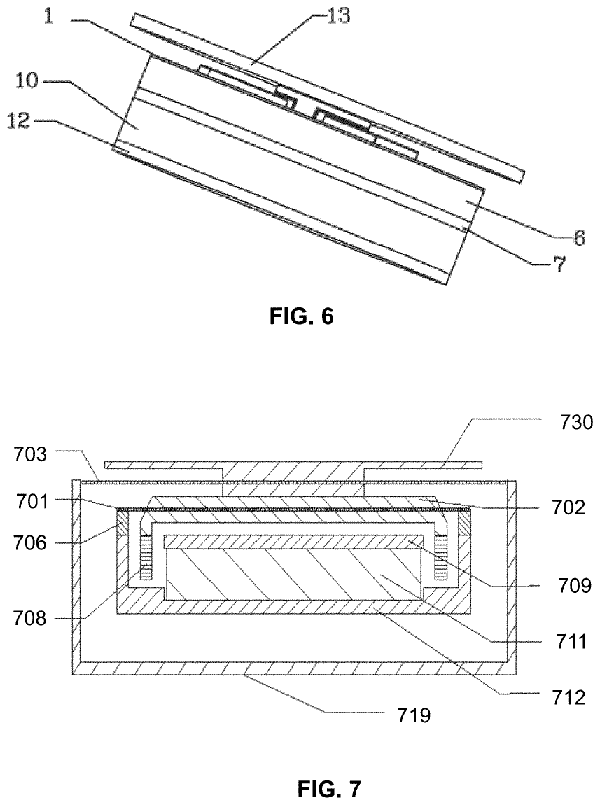

In the better implement examples of the present bone conduction speaker and its compound vibration device, the magnet system, composed of the annular magnet conductive plate 7, annular magnet 10, inner magnet conduction plate 9, inner magnet 11 and bottom plate 12, interacts with the voice coil which generates changing magnet field intensity when its current is changing, and inductance changes accordingly, forces the voice coil 8 move longitudinally, then causes the vibration board 2 to vibrate, transfers the vibration to the vibration conductive plate 1, then, through the contact between panel 13 and the post ear, cheeks or forehead of the human beings, transfers the vibrations to human bones, thus generates sounds. A complete product unit is shown in FIG. 6.

Through the compound vibration device composed of the vibration board and the vibration conductive plate, a frequency response shown in FIG. 5 is achieved. The double compound vibration generates two resonance peaks, whose positions can be changed by adjusting the parameters including sizes and materials of the two vibration parts, making the resonance peak in low frequency area move to the lower frequency area and the peak in high frequency move higher, finally generates a frequency response curve as the dotted line shown in FIG. 5, which is a flat frequency response curve generated in an ideal condition, whose resonance peaks are among the frequencies catchable with human ears. Thus, the device widens the resonance oscillation ranges, and generates the ideal voices.

In some embodiments, the stiffness of the vibration board may be larger than that of the vibration conductive plate. In some embodiments, the resonance peaks of the frequency response curve may be set within a frequency range perceivable by human ears, or a frequency range that a person's ears may not hear. Preferably, the two resonance peaks may be beyond the frequency range that a person may hear. More preferably, one resonance peak may be within the frequency range perceivable by human ears, and another one may be beyond the frequency range that a person may hear. More preferably, the two resonance peaks may be within the frequency range perceivable by human ears. Further preferably, the two resonance peaks may be within the frequency range perceivable by human ears, and the peak frequency may be in a range of 80 Hz-18000 Hz. Further preferably, the two resonance peaks may be within the frequency range perceivable by human ears, and the peak frequency may be in a range of 200 Hz-15000 Hz. Further preferably, the two resonance peaks may be within the frequency range perceivable by human ears, and the peak frequency may be in a range of 500 Hz-12000 Hz. Further preferably, the two resonance peaks may be within the frequency range perceivable by human ears, and the peak frequency may be in a range of 800 Hz-11000 Hz. There may be a difference between the frequency values of the resonance peaks. For example, the difference between the frequency values of the two resonance peaks may be at least 500 Hz, preferably 1000 Hz, more preferably 2000 Hz, and more preferably 5000 Hz. To achieve a better effect, the two resonance peaks may be within the frequency range perceivable by human ears, and the difference between the frequency values of the two resonance peaks may be at least 500 Hz. Preferably, the two resonance peaks may be within the frequency range perceivable by human ears, and the difference between the frequency values of the two resonance peaks may be at least 1000 Hz. More preferably, the two resonance peaks may be within the frequency range perceivable by human ears, and the difference between the frequency values of the two resonance peaks may be at least 2000 Hz. More preferably, the two resonance peaks may be within the frequency range perceivable by human ears, and the difference between the frequency values of the two resonance peaks may be at least 3000 Hz. Moreover, more preferably, the two resonance peaks may be within the frequency range perceivable by human ears, and the difference between the frequency values of the two resonance peaks may be at least 4000 Hz. One resonance peak may be within the frequency range perceivable by human ears, another one may be beyond the frequency range that a person may hear, and the difference between the frequency values of the two resonance peaks may be at least 500 Hz. Preferably, one resonance peak may be within the frequency range perceivable by human ears, another one may be beyond the frequency range that a person may hear, and the difference between the frequency values of the two resonance peaks may be at least 1000 Hz. More preferably, one resonance peak may be within the frequency range perceivable by human ears, another one may be beyond the frequency range that a person may hear, and the difference between the frequency values of the two resonance peaks may be at least 2000 Hz. More preferably, one resonance peak may be within the frequency range perceivable by human ears, another one may be beyond the frequency range that a person may hear, and the difference between the frequency values of the two resonance peaks may be at least 3000 Hz. Moreover, more preferably, one resonance peak may be within the frequency range perceivable by human ears, another one may be beyond the frequency range that a person may hear, and the difference between the frequency values of the two resonance peaks may be at least 4000 Hz. Both resonance peaks may be within the frequency range of 5 Hz-30000 Hz, and the difference between the frequency values of the two resonance peaks may be at least 400 Hz. Preferably, both resonance peaks may be within the frequency range of 5 Hz-30000 Hz, and the difference between the frequency values of the two resonance peaks may be at least 1000 Hz. More preferably, both resonance peaks may be within the frequency range of 5 Hz-30000 Hz, and the difference between the frequency values of the two resonance peaks may be at least 2000 Hz. More preferably, both resonance peaks may be within the frequency range of 5 Hz-30000 Hz, and the difference between the frequency values of the two resonance peaks may be at least 3000 Hz. Moreover, further preferably, both resonance peaks may be within the frequency range of 5 Hz-30000 Hz, and the difference between the frequency values of the two resonance peaks may be at least 4000 Hz. Both resonance peaks may be within the frequency range of 20 Hz-20000 Hz, and the difference between the frequency values of the two resonance peaks may be at least 400 Hz. Preferably, both resonance peaks may be within the frequency range of 20 Hz-20000 Hz, and the difference between the frequency values of the two resonance peaks may be at least 1000 Hz. More preferably, both resonance peaks may be within the frequency range of 20 Hz-20000 Hz, and the difference between the frequency values of the two resonance peaks may be at least 2000 Hz. More preferably, both resonance peaks may be within the frequency range of 20 Hz-20000 Hz, and the difference between the frequency values of the two resonance peaks may be at least 3000 Hz. And further preferably, both resonance peaks may be within the frequency range of 20 Hz-20000 Hz, and the difference between the frequency values of the two resonance peaks may be at least 4000 Hz. Both the two resonance peaks may be within the frequency range of 100 Hz-18000 Hz, and the difference between the frequency values of the two resonance peaks may be at least 400 Hz. Preferably, both resonance peaks may be within the frequency range of 100 Hz-18000 Hz, and the difference between the frequency values of the two resonance peaks may be at least 1000 Hz. More preferably, both resonance peaks may be within the frequency range of 100 Hz-18000 Hz, and the difference between the frequency values of the two resonance peaks may be at least 2000 Hz. More preferably, both resonance peaks may be within the frequency range of 100 Hz-18000 Hz, and the difference between the frequency values of the two resonance peaks may be at least 3000 Hz. And further preferably, both resonance peaks may be within the frequency range of 100 Hz-18000 Hz, and the difference between the frequency values of the two resonance peaks may be at least 4000 Hz. Both the two resonance peaks may be within the frequency range of 200 Hz-12000 Hz, and the difference between the frequency values of the two resonance peaks may be at least 400 Hz. Preferably, both resonance peaks may be within the frequency range of 200 Hz-12000 Hz, and the difference between the frequency values of the two resonance peaks may be at least 1000 Hz. More preferably, both resonance peaks may be within the frequency range of 200 Hz-12000 Hz, and the difference between the frequency values of the two resonance peaks may be at least 2000 Hz. More preferably, both resonance peaks may be within the frequency range of 200 Hz-12000 Hz, and the difference between the frequency values of the two resonance peaks may be at least 3000 Hz. And further preferably, both resonance peaks may be within the frequency range of 200 Hz-12000 Hz, and the difference between the frequency values of the two resonance peaks may be at least 4000 Hz. Both the two resonance peaks may be within the frequency range of 500 Hz-10000 Hz, and the difference between the frequency values of the two resonance peaks may be at least 400 Hz. Preferably, both resonance peaks may be within the frequency range of 500 Hz-10000 Hz, and the difference between the frequency values of the two resonance peaks may be at least 1000 Hz. More preferably, both resonance peaks may be within the frequency range of 500 Hz-10000 Hz, and the difference between the frequency values of the two resonance peaks may be at least 2000 Hz. More preferably, both resonance peaks may be within the frequency range of 500 Hz-10000 Hz, and the difference between the frequency values of the two resonance peaks may be at least 3000 Hz. And further preferably, both resonance peaks may be within the frequency range of 500 Hz-10000 Hz, and the difference between the frequency values of the two resonance peaks may be at least 4000 Hz. This may broaden the range of the resonance response of the speaker, thus obtaining a more ideal sound quality. It should be noted that in actual applications, there may be multiple vibration conductive plates and vibration boards to form multi-layer vibration structures corresponding to different ranges of frequency response, thus obtaining diatonic, full-ranged and high-quality vibrations of the speaker, or may make the frequency response curve meet requirements in a specific frequency range. For example, to satisfy the requirement of normal hearing, a bone conduction hearing aid may be configured to have a transducer including one or more vibration boards and vibration conductive plates with a resonance frequency in a range of 100 Hz-10000 Hz.

In the better implement examples, but, not limited to these examples, it is adopted that, the vibration conductive plate can be made by stainless steels, with a thickness of 0.1-0.2 mm, and when the middle three rods of the first rods group in the vibration conductive plate have a width of 0.5-1.0 mm, the low frequency resonance oscillation peak of the bone conduction speaker is located between 300 and 900 Hz. And, when the three straight rods in the second rods group have a width between 1.6 and 2.6 mm, and a thickness between 0.8 and 1.2 mm, the high frequency resonance oscillation peak of the bone conduction speaker is between 7500 and 9500 Hz. Also, the structures of the vibration conductive plate and the vibration board is not limited to three straight rods, as long as their structures can make a suitable flexibility to both vibration conductive plate and vibration board, cross-shaped rods and other rod structures are also suitable. Of course, with more compound vibration parts, more resonance oscillation peaks will be achieved, and the fitting curve will be flatter and the sound wider. Thus, in the better implement examples, more than two vibration parts, including the vibration conductive plate and vibration board as well as similar parts, overlapping each other, is also applicable, just needs more costs.

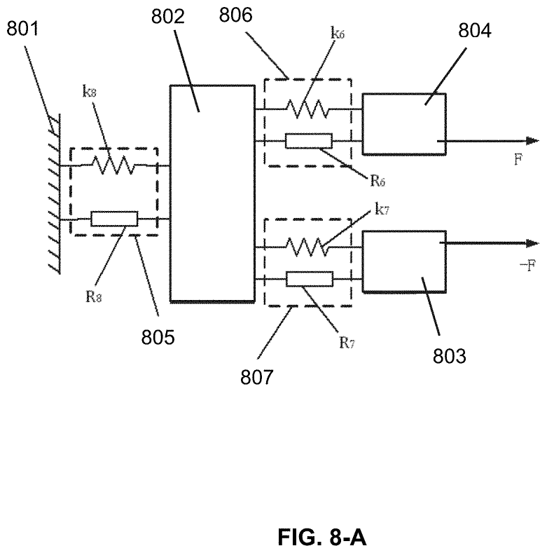

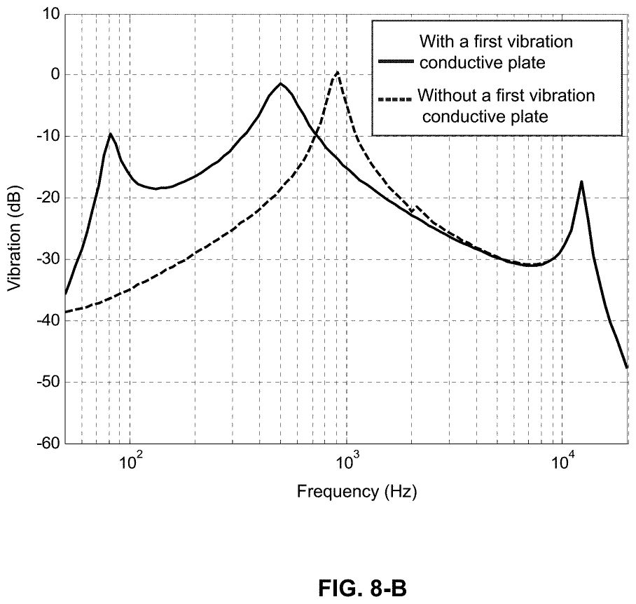

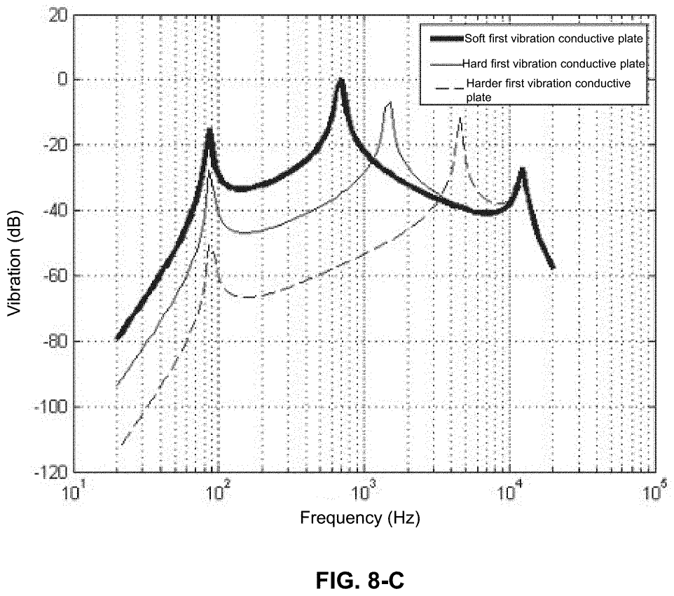

As shown in FIG. 7, in another embodiment, the compound vibration device (also referred to as “compound vibration system”) may include a vibration board 702, a first vibration conductive plate 703, and a second vibration conductive plate 701. The first vibration conductive plate 703 may fix the vibration board 702 and the second vibration conductive plate 701 onto a housing 719. The compound vibration system including the vibration board 702, the first vibration conductive plate 703, and the second vibration conductive plate 701 may lead to no less than two resonance peaks and a smoother frequency response curve in the range of the auditory system, thus improving the sound quality of the bone conduction speaker. The equivalent model of the compound vibration system may be shown in FIG. 8-A:

For illustration purposes, 801 represents a housing, 802 represents a panel, 803 represents a voice coil, 804 represents a magnetic circuit system, 805 represents a first vibration conductive plate, 806 represents a second vibration conductive plate, and 807 represents a vibration board. The first vibration conductive plate, the second vibration conductive plate, and the vibration board may be abstracted as components with elasticity and damping; the housing, the panel, the voice coil and the magnetic circuit system may be abstracted as equivalent mass blocks. The vibration equation of the system may be expressed as:

m₆x₆″+R₆(x₆−x₅)′+k₆(x₆−x₅)=F, (1)

x₇″R₇(x₇−x₅)′+k₇(x₇−x₅)=−F, (2)

m₅x₅″−R₆(x₆−x₅)′−R₇(x₇−x₅)′+R₈x₅′+k₈x₅−k₆(x₆−x₅)−k₇(x₇−x₅)=0, (3)

wherein, F is a driving force, k₆ is an equivalent stiffness coefficient of the second vibration conductive plate, k₇ is an equivalent stiffness coefficient of the vibration board, k₈ is an equivalent stiffness coefficient of the first vibration conductive plate, R₆ is an equivalent damping of the second vibration conductive plate, R₇ is an equivalent damping of the vibration board, R₈ is an equivalent damp of the first vibration conductive plate, m₅ is a mass of the panel, m₆ is a mass of the magnetic circuit system, m₇ is a mass of the voice coil, x₅ is a displacement of the panel, x₆ is a displacement of the magnetic circuit system, x₇ is to displacement of the voice coil, and the amplitude of the panel 802 may be:

$${A}_{5} = \frac{( - {m}_{6} {ω}^{2} ( j {R}_{7} ω - {k}_{7} ) + {m}_{7} {ω}^{2} ( {jR}_{6} ω - {k}_{6} ) )}{( \begin{matrix}\begin{matrix}\begin{matrix}( - {m}_{5} {ω}^{2} - {jR}_{8} ω + {k}_{8} ) ( - {m}_{6} {ω}^{2} - {jR}_{6} ω + {k}_{6} ) \\ ( - {m}_{7} {ω}^{2} - {jR}_{7} ω + {k}_{7} ) - {m}_{6} {ω}^{2} ( - {jR}_{6} ω + {k}_{6} )\end{matrix} \\ ( - {m}_{7} {ω}^{2} - {jR}_{7} ω + {k}_{7} ) - {m}_{7} {ω}^{2} ( - {jR}_{7} ω + {k}_{7} )\end{matrix} \\ ( - {m}_{6} {ω}^{2} - {jR}_{6} ω + {k}_{6} )\end{matrix} )} {f}_{0} , \qquad ( 4 )$$

wherein ω is an angular frequency of the vibration, and f₈ is a unit driving force.

The vibration system of the bone conduction speaker may transfer vibrations to a user via a panel (e.g., the panel 730 shown in FIG. 7). According to the equation (4), the vibration efficiency may relate to the stiffness coefficients of the vibration board, the first vibration conductive plate, and the second vibration conductive plate, and the vibration damping. Preferably, the stiffness coefficient of the vibration board k₇ may be greater than the second vibration coefficient k₆, and the stiffness coefficient of the vibration board k₇ may be greater than the first vibration factor k₈. The number of resonance peaks generated by the compound vibration system with the first vibration conductive plate may be more than the compound vibration system without the first vibration conductive plate, preferably at least three resonance peaks. More preferably, at least one resonance peak may be beyond the range perceivable by human ears. More preferably, the resonance peaks may be within the range perceivable by human ears. More further preferably, the resonance peaks may be within the range perceivable by human ears, and the frequency peak value may be no more than 18000 Hz. More preferably, the resonance peaks may be within the range perceivable by human ears, and the frequency peak value may be within the frequency range of 100 Hz-15000 Hz. More preferably, the resonance peaks may be within the range perceivable by human ears, and the frequency peak value may be within the frequency range of 200 Hz-12000 Hz. More preferably, the resonance peaks may be within the range perceivable by human ears, and the frequency peak value may be within the frequency range of 500 Hz-11000 Hz. There may be differences between the frequency values of the resonance peaks. For example, there may be at least two resonance peaks with a difference of the frequency values between the two resonance peaks no less than 200 Hz. Preferably, there may be at least two resonance peaks with a difference of the frequency values between the two resonance peaks no less than 500 Hz. More preferably, there may be at least two resonance peaks with a difference of the frequency values between the two resonance peaks no less than 1000 Hz. More preferably, there may be at least two resonance peaks with a difference of the frequency values between the two resonance peaks no less than 2000 Hz. More preferably, there may be at least two resonance peaks with a difference of the frequency values between the two resonance peaks no less than 5000 Hz. To achieve a better effect, all of the resonance peaks may be within the range perceivable by human ears, and there may be at least two resonance peaks with a difference of the frequency values between the two resonance peaks no less than 500 Hz. Preferably, all of the resonance peaks may be within the range perceivable by human ears, and there may be at least two resonance peaks with a difference of the frequency values between the two resonance peaks no less than 1000 Hz. More preferably, all of the resonance peaks may be within the range perceivable by human ears, and there may be at least two resonance peaks with a difference of the frequency values between the two resonance peaks no less than 2000 Hz. More preferably, all of the resonance peaks may be within the range perceivable by human ears, and there may be at least two resonance peaks with a difference of the frequency values between the two resonance peaks no less than 3000 Hz. More preferably, all of the resonance peaks may be within the range perceivable by human ears, and there may be at least two resonance peaks with a difference of the frequency values between the two resonance peaks no less than 4000 Hz. Two of the three resonance peaks may be within the frequency range perceivable by human ears, and another one may be beyond the frequency range that a person may hear, and there may be at least two resonance peaks with a difference of the frequency values between the two resonance peaks no less than 500 Hz. Preferably, two of the three resonance peaks may be within the frequency range perceivable by human ears, and another one may be beyond the frequency range that a person may hear, and there may be at least two resonance peaks with a difference of the frequency values between the two resonance peaks no less than 1000 Hz. More preferably, two of the three resonance peaks may be within the frequency range perceivable by human ears, and another one may be beyond the frequency range that a person may hear, and there may be at least two resonance peaks with a difference of the frequency values between the two resonance peaks no less than 2000 Hz. More preferably, two of the three resonance peaks may be within the frequency range perceivable by human ears, and another one may be beyond the frequency range that a person may hear, and there may be at least two resonance peaks with a difference of the frequency values between the two resonance peaks no less than 3000 Hz. More preferably, two of the three resonance peaks may be within the frequency range perceivable by human ears, and another one may be beyond the frequency range that a person may hear, and there may be at least two resonance peaks with a difference of the frequency values between the two resonance peaks no less than 4000 Hz. One of the three resonance peaks may be within the frequency range perceivable by human ears, and the other two may be beyond the frequency range that a person may hear, and there may be at least two resonance peaks with a difference of the frequency values between the two resonance peaks no less than 500 Hz. Preferably, one of the three resonance peaks may be within the frequency range perceivable by human ears, and the other two may be beyond the frequency range that a person may hear, and there may be at least two resonance peaks with a difference of the frequency values between the two resonance peaks no less than 1000 Hz. More preferably, one of the three resonance peaks may be within the frequency range perceivable by human ears, and the other two may be beyond the frequency range that a person may hear, and there may be at least two resonance peaks with a difference of the frequency values between the two resonance peaks no less than 2000 Hz. More preferably, one of the three resonance peaks may be within the frequency range perceivable by human ears, and the other two may be beyond the frequency range that a person may hear, and there may be at least two resonance peaks with a difference of the frequency values between the two resonance peaks no less than 3000 Hz. More preferably, one of the three resonance peaks may be within the frequency range perceivable by human ears, and the other two may be beyond the frequency range that a person may hear, and there may be at least two resonance peaks with a difference of the frequency values between the two resonance peaks no less than 4000 Hz. All the resonance peaks may be within the frequency range of 5 Hz-30000 Hz, and there may be at least two resonance peaks with a difference of the frequency values between the two resonance peaks of at least 400 Hz. Preferably, all the resonance peaks may be within the frequency range of 5 Hz-30000 Hz, and there may be at least two resonance peaks with a difference of the frequency values between the two resonance peaks of at least 1000 Hz. More preferably, all the resonance peaks may be within the frequency range of 5 Hz-30000 Hz, and there may be at least two resonance peaks with a difference of the frequency values between the two resonance peaks of at least 2000 Hz. More preferably, all the resonance peaks may be within the frequency range of 5 Hz-30000 Hz, and there may be at least two resonance peaks with a difference of the frequency values between the two resonance peaks of at least 3000 Hz. And further preferably, all the resonance peaks may be within the frequency range of 5 Hz-30000 Hz, and there may be at least two resonance peaks with a difference of the frequency values between the two resonance peaks of at least 4000 Hz. All the resonance peaks may be within the frequency range of 20 Hz-20000 Hz, and there may be at least two resonance peaks with a difference of the frequency values between the two resonance peaks of at least 400 Hz. Preferably, all the resonance peaks may be within the frequency range of 20 Hz-20000 Hz, and there may be at least two resonance peaks with a difference of the frequency values between the two resonance peaks of at least 1000 Hz. More preferably, all the resonance peaks may be within the frequency range of 20 Hz-20000 Hz, and there may be at least two resonance peaks with a difference of the frequency values between the two resonance peaks of at least 2000 Hz. More preferably, all the resonance peaks may be within the frequency range of 20 Hz-20000 Hz, and there may be at least two resonance peaks with a difference of the frequency values between the two resonance peaks of at least 3000 Hz. And further preferably, all the resonance peaks may be within the frequency range of 20 Hz-20000 Hz, and there may be at least two resonance peaks with a difference of the frequency values between the two resonance peaks of at least 4000 Hz. All the resonance peaks may be within the frequency range of 100 Hz-18000 Hz, and there may be at least two resonance peaks with a difference of the frequency values between the two resonance peaks of at least 400 Hz. Preferably, all the resonance peaks may be within the frequency range of 100 Hz-18000 Hz, and there may be at least two resonance peaks with a difference of the frequency values between the two resonance peaks of at least 1000 Hz. More preferably, all the resonance peaks may be within the frequency range of 100 Hz-18000 Hz, and there may be at least two resonance peaks with a difference of the frequency values between the two resonance peaks of at least 2000 Hz. More preferably, all the resonance peaks may be within the frequency range of 100 Hz-18000 Hz, and there may be at least two resonance peaks with a difference of the frequency values between the two resonance peaks of at least 3000 Hz. And further preferably, all the resonance peaks may be within the frequency range of 100 Hz-18000 Hz, and there may be at least two resonance peaks with a difference of the frequency values between the two resonance peaks of at least 4000 Hz. All the resonance peaks may be within the frequency range of 200 Hz-12000 Hz, and there may be at least two resonance peaks with a difference of the frequency values between the two resonance peaks of at least 400 Hz. Preferably, all the resonance peaks may be within the frequency range of 200 Hz-12000 Hz, and there may be at least two resonance peaks with a difference of the frequency values between the two resonance peaks of at least 1000 Hz. More preferably, all the resonance peaks may be within the frequency range of 200 Hz-12000 Hz, and there may be at least two resonance peaks with a difference of the frequency values between the two resonance peaks of at least 2000 Hz. More preferably, all the resonance peaks may be within the frequency range of 200 Hz-12000 Hz, and there may be at least two resonance peaks with a difference of the frequency values between the two resonance peaks of at least 3000 Hz. And further preferably, all the resonance peaks may be within the frequency range of 200 Hz-12000 Hz, and there may be at least two resonance peaks with a difference of the frequency values between the two resonance peaks of at least 4000 Hz. All the resonance peaks may be within the frequency range of 500 Hz-10000 Hz, and there may be at least two resonance peaks with a difference of the frequency values between the two resonance peaks of at least 400 Hz. Preferably, all the resonance peaks may be within the frequency range of 500 Hz-10000 Hz, and there may be at least two resonance peaks with a difference of the frequency values between the two resonance peaks of at least 1000 Hz. More preferably, all the resonance peaks may be within the frequency range of 500 Hz-10000 Hz, and there may be at least two resonance peaks with a difference of the frequency values between the two resonance peaks of at least 2000 Hz. More preferably, all the resonance peaks may be within the frequency range of 500 Hz-10000 Hz, and there may be at least two resonance peaks with a difference of the frequency values between the two resonance peaks of at least 3000 Hz. Moreover, further preferably, all the resonance peaks may be within the frequency range of 500 Hz-10000 Hz, and there may be at least two resonance peaks with a difference of the frequency values between the two resonance peaks of at least 4000 Hz. In one embodiment, the compound vibration system including the vibration board, the first vibration conductive plate, and the second vibration conductive plate may generate a frequency response as shown in FIG. 8-B. The compound vibration system with the first vibration conductive plate may generate three obvious resonance peaks, which may improve the sensitivity of the frequency response in the low-frequency range (about 600 Hz), obtain a smoother frequency response, and improve the sound quality.

The resonance peak may be shifted by changing a parameter of the first vibration conductive plate, such as the size and material, so as to obtain an ideal frequency response eventually. For example, the stiffness coefficient of the first vibration conductive plate may be reduced to a designed value, causing the resonance peak to move to a designed low frequency, thus enhancing the sensitivity of the bone conduction speaker in the low frequency, and improving the quality of the sound. As shown in FIG. 8-C, as the stiffness coefficient of the first vibration conductive plate decreases (i.e., the first vibration conductive plate becomes softer), the resonance peak moves to the low frequency region, and the sensitivity of the frequency response of the bone conduction speaker in the low frequency region gets improved. Preferably, the first vibration conductive plate may be an elastic plate, and the elasticity may be determined based on the material, thickness, structure, or the like. The material of the first vibration conductive plate may include but not limited to steel (for example but not limited to, stainless steel, carbon steel, etc.), light alloy (for example but not limited to, aluminum, beryllium copper, magnesium alloy, titanium alloy, etc.), plastic (for example but not limited to, polyethylene, nylon blow molding, plastic, etc.). It may be a single material or a composite material that achieve the same performance. The composite material may include but not limited to reinforced material, such as glass fiber, carbon fiber, boron fiber, graphite fiber, graphene fiber, silicon carbide fiber, aramid fiber, or the like. The composite material may also be other organic and/or inorganic composite materials, such as various types of glass fiber reinforced by unsaturated polyester and epoxy, fiberglass comprising phenolic resin matrix. The thickness of the first vibration conductive plate may be not less than 0.005 mm. Preferably, the thickness may be 0.005 mm-3 mm. More preferably, the thickness may be 0.01 mm-2 mm. More preferably, the thickness may be 0.01 mm-1 mm. Moreover, further preferably, the thickness may be 0.02 mm-0.5 mm. The first vibration conductive plate may have an annular structure, preferably including at least one annular ring, preferably, including at least two annular rings. The annular ring may be a concentric ring or a non-concentric ring and may be connected to each other via at least two rods converging from the outer ring to the center of the inner ring. More preferably, there may be at least one oval ring. More preferably, there may be at least two oval rings. Different oval rings may have different curvatures radiuses, and the oval rings may be connected to each other via rods. Further preferably, there may be at least one square ring. The first vibration conductive plate may also have the shape of a plate. Preferably, a hollow pattern may be configured on the plate. Moreover, more preferably, the area of the hollow pattern may be not less than the area of the non-hollow portion. It should be noted that the above-described material, structure, or thickness may be combined in any manner to obtain different vibration conductive plates. For example, the annular vibration conductive plate may have a different thickness distribution. Preferably, the thickness of the ring may be equal to the thickness of the rod. Further preferably, the thickness of the rod may be larger than the thickness of the ring. Moreover, still, further preferably, the thickness of the inner ring may be larger than the thickness of the outer ring.

When the compound vibration device is applied to the bone conduction speaker, the major applicable area is bone conduction earphones. Thus the bone conduction speaker adopting the structure will be fallen into the protection of the present disclosure.

The bone conduction speaker and its compound vibration device stated in the present disclosure, make the technique simpler with a lower cost. Because the two parts in the compound vibration device can adjust the low frequency as well as the high frequency ranges, as shown in FIG. 5, which makes the achieved frequency response flatter, and voice more broader, avoiding the problem of abrupt frequency response and feeble voices caused by single vibration device, thus broaden the application prospection of bone conduction speaker.

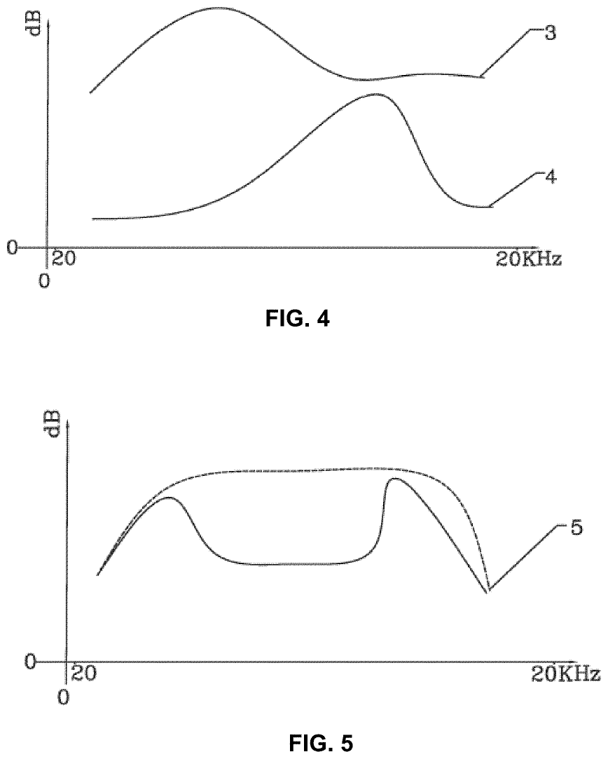

In the prior art, the vibration parts did not take full account of the effects of every part to the frequency response, thus, although they could have the similar outlooks with the products described in the present disclosure, they will generate an abrupt frequency response, or feeble sound. And due to the improper matching between different parts, the resonance peak could have exceeded the human hearable range, which is between 20 Hz and 20 KHz. Thus, only one sharp resonance peak as shown in FIG. 4 appears, which means a pretty poor tone quality.

It should be made clear that, the above detailed description of the better implement examples should not be considered as the limitations to the present disclosure protections. The extent of the patent protection of the present disclosure should be determined by the terms of claims.

### EXAMPLES

### Example 1

A bone conduction speaker may include a U-shaped headset bracket/headset lanyard, two vibration units, a transducer connected to each vibration unit. The vibration unit may include a contact surface and a housing. The contact surface may be an outer surface of a silicone rubber transfer layer and may be configured to have a gradient structure including a convex portion. A clamping force between the contact surface and skin due to the headset bracket/headset lanyard may be unevenly distributed on the contact surface. The sound transfer efficiency of the portion of the gradient structure may be different from the portion without the gradient structure.

### Example 2

This example may be different from Example 1 in the following aspects. The headset bracket/headset lanyard as described may include a memory alloy. The headset bracket/headset lanyard may match the curves of different users' heads and have a good elasticity and a better wearing comfort. The headset bracket/headset lanyard may recover to its original shape from a deformed status last for a certain period. As used herein, the certain period may refer to ten minutes, thirty minutes, one hour, two hours, five hours, or may also refer to one day, two days, ten days, one month, one year, or a longer period. The clamping force that the headset bracket/headset lanyard provides may keep stable, and may not decline gradually over time. The force intensity between the bone conduction speaker and the body surface of a user may be within an appropriate range, so as to avoid pain or clear vibration sense caused by undue force when the user wears the bone conduction speaker. Moreover, the clamping force of bone conduction speaker may be within a range of 0.2N˜1.5N when the bone conduction speaker is used.

### Example 3

The difference between this example and the two examples mentioned above may include the following aspects. The elastic coefficient of the headset bracket/headset lanyard may be kept in a specific range, which results in the value of the frequency response curve in low frequency (e.g., under 500 Hz) being higher than the value of the frequency response curve in high frequency (e.g., above 4000 Hz).

### Example 4

The difference between Example 4 and Example 1 may include the following aspects. The bone conduction speaker may be mounted on an eyeglass frame, or in a helmet or mask with a special function.

### Example 5

The difference between this example and Example 1 may include the following aspects. The vibration unit may include two or more panels, and the different panels or the vibration transfer layers connected to the different panels may have different gradient structures on a contact surface being in contact with a user. For example, one contact surface may have a convex portion, the other one may have a concave structure, or the gradient structures on both the two contact surfaces may be convex portions or concave structures, but there may be at least one difference between the shape or the number of the convex portions.

### Example 6

A portable bone conduction hearing aid may include multiple frequency response curves. A user or a tester may choose a proper response curve for hearing compensation according to an actual response curve of the auditory system of a person. In addition, according to an actual requirement, a vibration unit in the bone conduction hearing aid may enable the bone conduction hearing aid to generate an ideal frequency response in a specific frequency range, such as 500 Hz-4000 Hz.

### Example 7

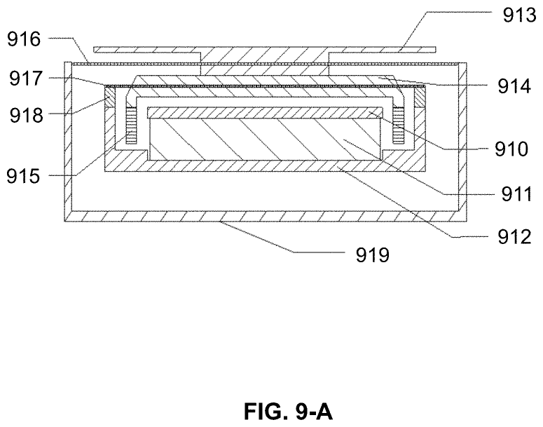

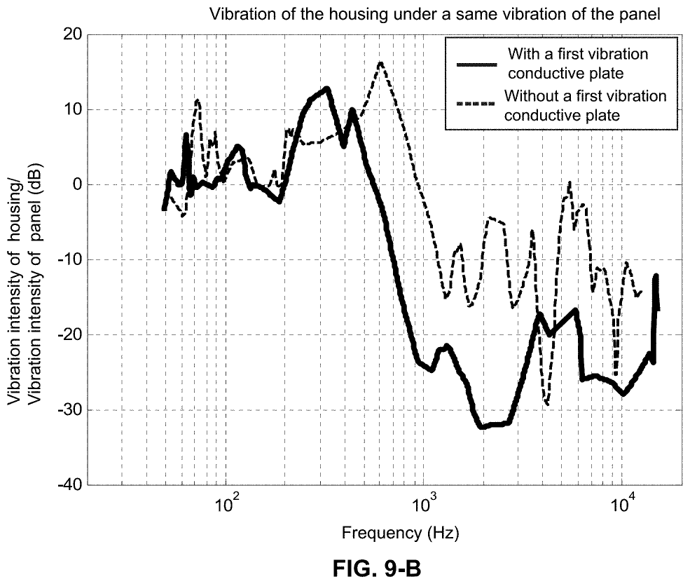

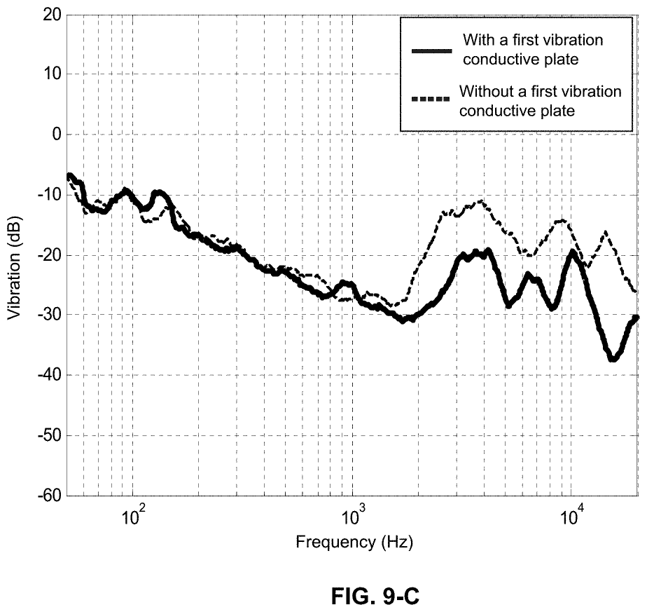

A vibration generation portion of a bone conduction speaker may be shown in FIG. 9-A. A transducer of the bone conduction speaker may include a magnetic circuit system including a magnetic flux conduction plate 910, a magnet 911 and a magnetizer 912, a vibration board 914, a coil 915, a first vibration conductive plate 916, and a second vibration conductive plate 917. The panel 913 may protrude out of the housing 919 and may be connected to the vibration board 914 by glue. The transducer may be fixed to the housing 919 via the first vibration conductive plate 916 forming a suspended structure.

A compound vibration system including the vibration board 914, the first vibration conductive plate 916, and the second vibration conductive plate 917 may generate a smoother frequency response curve, so as to improve the sound quality of the bone conduction speaker. The transducer may be fixed to the housing 919 via the first vibration conductive plate 916 to reduce the vibration that the transducer is transferring to the housing, thus effectively decreasing sound leakage caused by the vibration of the housing, and reducing the effect of the vibration of the housing on the sound quality. FIG. 9-B shows frequency response curves of the vibration intensities of the housing of the vibration generation portion and the panel. The bold line refers to the frequency response of the vibration generation portion including the first vibration conductive plate 916, and the thin line refers to the frequency response of the vibration generation portion without the first vibration conductive plate 916. As shown in FIG. 9-B, the vibration intensity of the housing of the bone conduction speaker without the first vibration conductive plate may be larger than that of the bone conduction speaker with the first vibration conductive plate when the frequency is higher than 500 Hz. FIG. 9-C shows a comparison of the sound leakage between a bone conduction speaker includes the first vibration conductive plate 916 and another bone conduction speaker does not include the first vibration conductive plate 916. The sound leakage when the bone conduction speaker includes the first vibration conductive plate may be smaller than the sound leakage when the bone conduction speaker does not include the first vibration conductive plate in the intermediate frequency range (for example, about 1000 Hz). It can be concluded that the use of the first vibration conductive plate between the panel and the housing may effectively reduce the vibration of the housing, thereby reducing the sound leakage.

The first vibration conductive plate may be made of the material, for example but not limited to stainless steel, copper, plastic, polycarbonate, or the like, and the thickness may be in a range of 0.01 mm-1 mm.

### Example 8

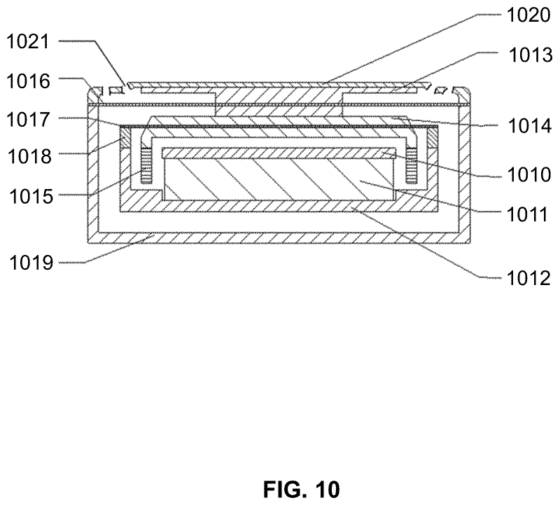

This example may be different with Example 7 in the following aspects. As shown in FIG. 10, the panel 1013 may be configured to have a vibration transfer layer 1020 (for example but not limited to, silicone rubber) to produce a certain deformation to match a user's skin. A contact portion being in contact with the panel 1013 on the vibration transfer layer 1020 may be higher than a portion not being in contact with the panel 1013 on the vibration transfer layer 1020 to form a step structure. The portion not being in contact with the panel 1013 on the vibration transfer layer 1020 may be configured to have one or more holes 1021. The holes on the vibration transfer layer may reduce the sound leakage: the connection between the panel 1013 and the housing 1019 via the vibration transfer layer 1020 may be weakened, and vibration transferred from panel 1013 to the housing 1019 via the vibration transfer layer 1020 may be reduced, thereby reducing the sound leakage caused by the vibration of the housing; the area of the vibration transfer layer 1020 configured to have holes on the portion without protrusion may be reduced, thereby reducing air and sound leakage caused by the vibration of the air; the vibration of air in the housing may be guided out, interfering with the vibration of air caused by the housing 1019, thereby reducing the sound leakage.

### Example 9

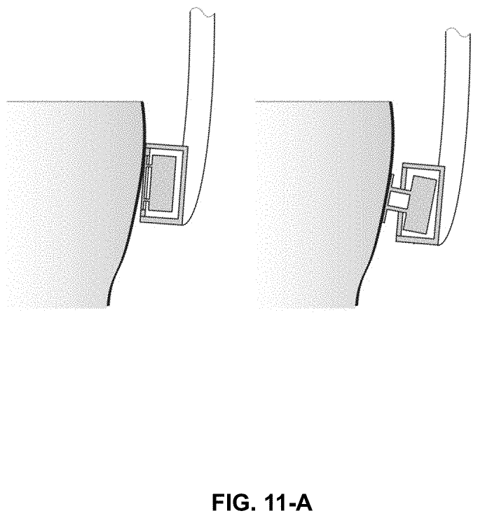

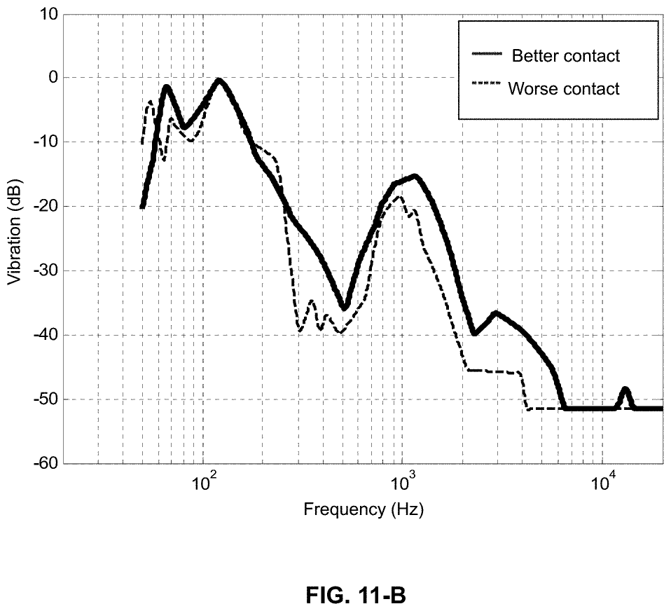

The difference between this example and Example 7 may include the following aspects. As the panel may protrude out of the housing, meanwhile, the panel may be connected to the housing via the first vibration conductive plate, the degree of coupling between the panel and the housing may be dramatically reduced, and the panel may be in contact with a user with a higher freedom to adapt complex contact surfaces (as shown in the right figure of FIG. 11-A) as the first vibration conductive plate provides a certain amount of deformation. The first vibration conductive plate may incline the panel relative to the housing with a certain angle. Preferably, the slope angle may not exceed 5 degrees.

The vibration efficiency may differ with contacting statuses. A better contacting status may lead to a higher vibration transfer efficiency. As shown in FIG. 11-B, the bold line shows the vibration transfer efficiency with a better contacting status, and the thin line shows a worse contacting status. It may be concluded that the better contacting status may correspond to a higher vibration transfer efficiency.

### Example 10

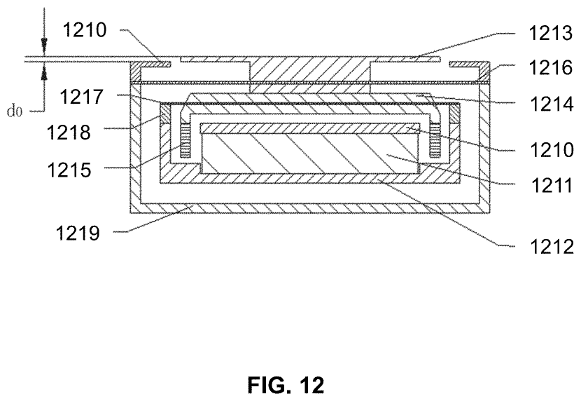

The difference between this example and Example 7 may include the following aspects. A boarder may be added to surround the housing. When the housing contact with a user's skin, the surrounding boarder may facilitate an even distribution of an applied force, and improve the user's wearing comfort. As shown in FIG. 12, there may be a height difference do between the surrounding border 1210 and the panel 1213. The force from the skin to the panel 1213 may decrease the distanced between the panel 1213 and the surrounding border 1210. When the force between the bone conduction speaker and the user is larger than the force applied to the first vibration conductive plate with a deformation of do, the extra force may be transferred to the user's skin via the surrounding border 1210, without influencing the clamping force of the vibration portion, with the consistency of the clamping force improved, thereby ensuring the sound quality.

### Example 11

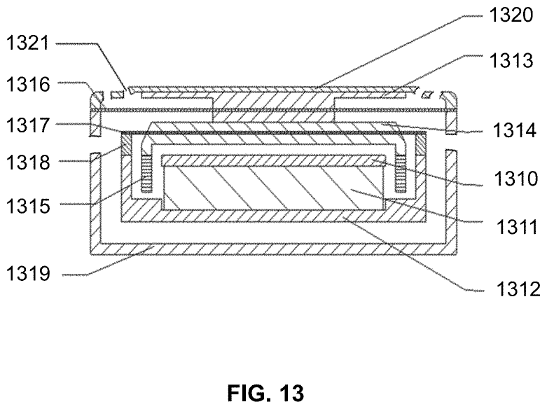

The difference between this example and Example 8 may include the following aspects. As shown in FIG. 13, sound guiding holes are located at the vibration transfer layer 1320 and the housing 1319, respectively. The acoustic wave formed by the vibration of the air in the housing is guided to the outside of the housing, and interferes with the leaked acoustic wave due to the vibration of the air out of the housing, thus reducing the sound leakage.

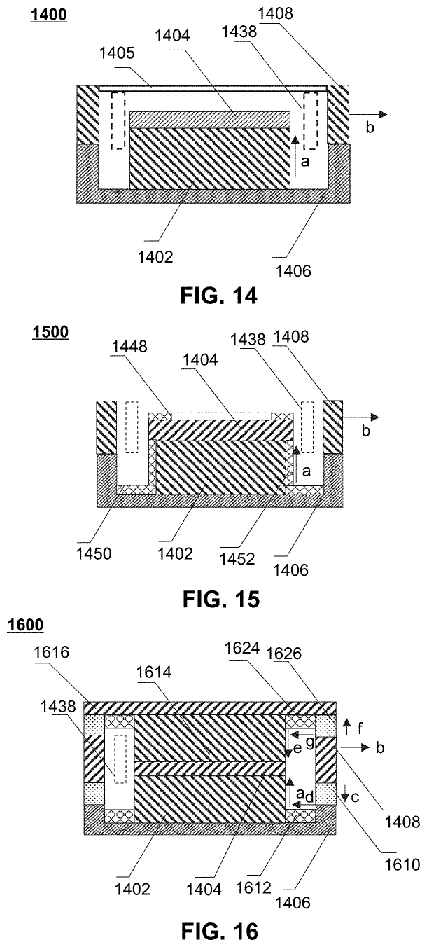

FIG. 14 is a schematic diagram illustrating a longitudinal sectional view of an exemplary speaker 1400 according to some embodiments of the present disclosure. It should be noted that, without departing from the spirit and scope of the present disclosure, the contents described below may be applied to an air conduction speaker and a bone conduction speaker.

As shown in FIG. 14, in some embodiments, the speaker 1400 may include a first magnetic component 1402, a first magnetic conductive component 1404, a second magnetic conductive component 1406, a second magnetic component 1408, a vibration board 1405, and a voice coil 1438. In some embodiments, the speaker 1400 may further include a vibration conductive plate (not shown in FIG. 14, e.g., the vibration conductive plate 1 illustrated in FIG. 1, the (second) vibration conductive plate 701 illustrated in FIG. 7, etc.). The vibration conductive plate may be physically connected with the vibration board 1405. Vibrations generated by the vibration conductive plate and the vibration board 1405 may have at least two resonance peaks. Frequencies of the at least two resonance peaks may be catchable with human ears. Sounds are generated by the vibrations transferred through a human bone or the air. In some embodiments, one or more of the components of speaker 1400 may form a magnetic system. For example, the magnetic system may include the first magnetic component 1402, the first magnetic conductive component 1404, the second magnetic conductive component 1406, and the second magnetic component 1408. The magnetic system may generate a first total magnetic field (or referred to as a total magnetic field of the magnetic system or a first magnetic field). The first total magnetic field may be formed by all magnetic fields generated by all components of the magnetic system (e.g., the first magnetic component 1402, the first magnetic conductive component 1404, the second magnetic conductive component 1406, and the second magnetic component 1408). In some embodiments, the magnetic system and the voice coil 1438 may collectively be referred to as a transducer.

A magnetic component used herein refers to any component that may generate a magnetic field, such as a magnet. In some embodiments, a magnetic component may have a magnetization direction, which refers to the direction of a magnetic field inside the magnetic component. In some embodiments, the first magnetic component 1402 may include a first magnet, which may generate a second magnetic field, and the second magnetic component 1408 may include a second magnet. The first magnet and the second magnet may be of the same type or different types. In some embodiments, a magnet may include a metal alloy magnet, a ferrite, or the like. The metal alloy magnet may include neodymium iron boron, samarium cobalt, aluminum nickel cobalt, iron chromium cobalt, aluminum iron boron, iron carbon aluminum, or the like, or any combination thereof. The ferrite may include barium ferrite, steel ferrite, ferromanganese ferrite, lithium manganese ferrite, or the like, or any combination thereof.

A magnetic conductive component may also be referred to as a magnetic field concentrator or an iron core. The magnetic conductive component may be used to form a magnetic field loop. The magnetic conductive component may adjust the distribution of a magnetic field (e.g., the second magnetic field generated by the first magnetic component 1402). In some embodiments, the magnetic conductive component may include a soft magnetic material. Exemplary soft magnetic materials may include a metal material, a metal alloy material, a metal oxide material, an amorphous metal material, or the like. For example, the soft magnetic material may include iron, iron-silicon based alloy, iron-aluminum based alloy, nickel-iron based alloy, iron-cobalt based alloy, low carbon steel, silicon steel sheet, silicon steel sheet, ferrite, or the like. In some embodiments, the magnetic conductive component may be manufactured by, for example, casting, plastic processing, cutting processing, powder metallurgy, or the like, or any combination thereof. The casting may include sand casting, investment casting, pressure casting, centrifugal casting, or the like. The plastic processing may include rolling, casting, forging, stamping, extrusion, drawing, or the like, or any combination thereof. The cutting processing may include turning, milling, planning, grinding, or the like. In some embodiments, the magnetic conductive component may be manufactured by a 3D printing technique, a computer numerical control machine tool, or the like.

In some embodiments, one or more of the first magnetic component 1402, the first magnetic conductive component 1404, and the second magnetic conductive component 1406 may have an axisymmetric structure. The axisymmetric structure may include a ring structure, a columnar structure, or other axisymmetric structures. For example, the structure of the first magnetic component 1402 and/or the first magnetic conductive component 1404 may be a cylinder, a rectangular parallelepiped, or a hollow ring (e.g., a cross-section of the hollow ring may be the shape of a racetrack). As another example, the structure of the first magnetic component 1402 and the structure of the first magnetic conductive component 1404 may be coaxial cylinders having the same diameter or different diameters. In some embodiments, the second magnetic conductive component 1406 may have a groove-shaped structure. The groove-shaped structure may include a U-shaped cross section (as shown in FIG. 14). The groove-shaped second magnetic conductive component 1406 may include a bottom plate and a side wall. In some embodiments, the bottom plate and the side wall may form an integral assembly. For example, the side wall may be formed by extending the bottom plate in a direction perpendicular to the bottom plate. In some embodiments, the bottom plate may be mechanically connected to the side wall. As used herein, a mechanical connection between two components may include a bonded connection, a locking connection, a welded connection, a rivet connection, a bolted connection, or the like, or any combination thereof.

The second magnetic component 1408 may have a shape of a ring or a sheet. For example, the second magnetic component 1408 may have a ring shape. The second magnetic component 1408 may include an inner ring and an outer ring. In some embodiments, the shape of the inner ring and/or the outer ring may be a circle, an ellipse, a triangle, a quadrangle, or any other polygon. In some embodiments, the second magnetic component 1408 may include a plurality of magnets. Two ends of a magnet of the plurality of magnets may be mechanically connected to or have a certain distance from the ends of an adjacent magnet. The distance between the adjacent magnets may be the same or different. For example, the second magnetic component 1408 may include two or three sheet-like magnets which are arranged equidistantly. The shape of a sheet-like magnet may be a fan shape, a quadrangular shape, or the like. In some embodiments, the second magnetic component 1408 may be coaxial with the first magnetic component 1402 and/or the first magnetic conductive component 1404.

In some embodiments, an upper surface of the first magnetic component 1402 may be mechanically connected to a lower surface of the first magnetic conductive component 1404 as shown in FIG. 14. A lower surface of the first magnetic component 1402 may be mechanically connected to the bottom plate of the second magnetic conductive component 1406. A lower surface of the second magnetic component 1408 may be mechanically connected to the side wall of the second magnetic conductive component 1406.

In some embodiments, a magnetic gap may be formed between the first magnetic component 1402 (and/or the first magnetic conductive component 1404) and the inner ring of the second magnetic component 1408 (and/or the second magnetic conductive component 1406). The voice coil 1438 may be disposed in the magnetic gap and mechanically connected to the vibration board 1405. A voice coil refers to an element that may transmit an audio signal. The voice coil 1438 may be located in a magnetic field formed by the first magnetic component 1402, the first magnetic conductive component 1404, the second magnetic conductive component 1406, and the second magnetic component 1408. When a current is applied to the voice coil 1438, the ampere force generated by the magnetic field may drive the voice coil 1438 to vibrate. The vibration of the voice coil 1438 may drive the vibration board 1405 to vibrate to generate sound waves, which may be transmitted to a user's ears via air conduction and/or the bone conduction. In some embodiments, the distance between the bottom of the voice coil 1438 and the second magnetic conductive component 1406 may be equal to that between the bottom of the second magnetic component 1408 and the second magnetic conductive component 1406.

In some embodiments, for a speaker device having a single magnetic component, the magnetic induction lines passing through the voice coil 1438 may be uneven and divergent. A magnetic leakage may be formed in the magnetic system, that is, some magnetic induction lines may leak outside the magnetic gap and fail to pass through the voice coil 1438. This may result in a decrease in a magnetic induction intensity (or a magnetic field intensity) at the voice coil 1438, and affect the sensitivity of the speaker 1400. To eliminate or reduce the magnetic leakage, the speaker 1400 may further include at least one second magnetic component and/or at least one third magnetic conductive component (not shown in the figure). The at least one second magnetic component and/or at least one third magnetic conductive component may suppress the magnetic leakage and restrict the shape of the magnetic induction lines passing through the voice coil 1438, so that more magnetic induction lines may pass through the voice coil 1438 horizontally and densely to enhance the magnetic induction intensity (or the magnetic field intensity) at the voice coil 1438. The sensitivity and the mechanical conversion efficiency of the speaker 1400 (i.e., the efficiency of converting an electric energy into a mechanical energy of the vibration of the voice coil 1438) may be improved.

In some embodiments, the magnetic field intensity (or referred to as a magnetic induction intensity or a magnetic induction lines density) of the first total magnetic field within the magnetic gap may be greater than that of the second magnetic field within the magnetic gap. In some embodiments, the second magnetic component 1408 may generate a third magnetic field, and the third magnetic field may increase the magnetic field intensity of the first total magnetic field within the magnetic gap. The third magnetic field increasing the magnetic field intensity of the first total magnetic field within the magnetic gap refers to that the magnetic field intensity of the first total magnetic field when the third magnetic field exists (i.e., a magnetic system includes the second magnetic component 1408) is greater than that when the third magnetic field doesn't exist (i.e., a magnetic system does not include the second magnetic component 1408). As used herein, unless otherwise specified, a magnetic system refers to a system that includes all magnetic component(s) and magnetic conductive component(s). The first total magnetic field refers to a magnetic field generated by the magnetic system. Each of the second magnetic field, the third magnetic field, . . . , and the N^{th} magnetic field refers to a magnetic field generated by a corresponding magnetic component. Different magnetic systems may unitize a same magnetic component or different magnetic components to generate the second magnetic field (or the third magnetic field, . . . , the N^{th} magnetic field).

In some embodiments, an angle (denoted as A1) between the magnetization direction of the first magnetic component 1402 and the magnetization direction of the second magnetic component 1408 may be in a range from 0 degree to 180 degrees. For example, the angle A1 may be in a range from 45 degrees to 135 degrees. As another example, the angle A1 may be equal to or greater than 90 degrees. In some embodiments, the magnetization direction of the first magnetic component 1402 may be parallel to an upward direction (as indicated by an arrow a in FIG. 14) that is perpendicular to the lower surface or the upper surface of the first magnetic component 1402. The magnetization direction of the second magnetic component 1408 may be parallel to a direction directed from the inner ring to the outer ring of the second magnetic component 1408 (as indicated by an arrow b as shown in FIG. 14 that is on the right side of the first magnetic component 1402, which can be obtained by rotating the magnetization direction of the first magnetic component 1402 by 90 degrees clockwise). The magnetization direction of the second magnetic component 1408 may be perpendicular to that of the first magnetic component 1402.

In some embodiments, at the position of the second magnetic component 1408, an angle (denoted as A2) between the direction of the first total magnetic field and the magnetization direction of the second magnetic component 1408 may be not greater than 90 degrees. In some embodiments, at the position of the second magnetic component 1408, an angle (denoted as A3) between the direction of the magnetic field generated by the first magnetic component 1402 and the magnetization direction of the second magnetic component 1408 may be less than or equal to 90 degrees, such as 0 degree, 10 degrees, or 20 degrees. Compared with a magnetic system with a single magnetic component, the second magnetic component 1408 may increase the total magnetic induction lines within the magnetic gap of the magnetic system of the speaker 1400, thereby increasing the magnetic induction intensity within the magnetic gap. In addition, due to the second magnetic component 1408, the originally scattered magnetic induction lines may be converged to the position of the magnetic gap, which may further increase the magnetic induction intensity within the magnetic gap.

FIG. 15 is a schematic diagram illustrating a longitudinal sectional view of an exemplary magnetic system 1500 according to some embodiments of the present disclosure. As shown in FIG. 15, different from the magnetic system of the speaker 1400, the magnetic system 1500 may further include at least one electric conductive component (e.g., a first electric conductive component 1448, a second electric conductive component 1450, and a third electric conductive component 1452).

In some embodiments, an electric conductive component may include a metal material, a metal alloy material, an inorganic non-metallic material, or other conductive material. Exemplary metal material may include gold, silver, copper, aluminum, or the like. Exemplary metal alloy material may include an iron-based alloy material, an aluminum-based alloy material, a copper-based alloy material, a zinc-based alloy material, or the like. Exemplary inorganic non-metallic material may include graphite, or the like. An electric conductive component may have a shape of a sheet, a ring, a mesh, or the like. The first electric conductive component 1448 may be disposed on the upper surface of the first magnetic conductive component 1404. The second electric conductive component 1450 may be mechanically connected to the first magnetic component 1402 and the second magnetic conductive component 1406. The third electric conductive component 1452 may be mechanically connected to the side wall of the first magnetic component 1402. In some embodiments, the first magnetic conductive component 1404 may protrude from the first magnetic component 1402 to form a first recess at the right side of the first magnetic component 1402 as shown in FIG. 15. The third electric conductive component 1452 may be disposed at the first recess. In some embodiments, the first electric conductive component 1448, the second electric conductive component 1450, and the third electric conductive component 1452 may include the same or different conductive materials.

In some embodiments, a magnetic gap may be formed between the first magnetic component 1402, the first magnetic conductive component 1404, and the inner ring of the second magnetic component 1408. The voice coil 1438 may be disposed in the magnetic gap. The first magnetic component 1402, the first magnetic conductive component 1404, the second magnetic conductive component 1406, and the second magnetic component 1408 may form the magnetic system 1500. In some embodiments, the electric conductive components of the magnetic system 1500 may reduce an inductive reactance of the voice coil 1438. For example, if a first alternating current is applied to the voice coil 1438, a first alternating magnetic field may be generated near the voice coil 1438. Under the action of the magnetic field of the magnetic system 1500, the first alternating magnetic field may cause the voice coil 1438 to generate an inductive reactance and hinder the movement of the voice coil 1438. One or more electric conductive components (e.g., the first electric conductive component 1448, the second electric conductive component 1450, and the third electric conductive component 1452) disposed near the voice coil 1438 may induce a second alternating current under the action of the first alternating magnetic field. The second alternating current induced by the electric conductive component(s) may generate a second alternating induction magnetic field in its vicinity. The direction of the second alternating magnetic field may be opposite to that of the first alternating magnetic field, and the first alternating magnetic field may be weakened. The inductive reactance of the voice coil 1438 may be reduced, the current in the voice coil 1438 may be increased, and the sensitivity of the speaker may be improved.

FIG. 16 is a schematic diagram illustrating a longitudinal sectional view of an exemplary magnetic system 1600 according to some embodiments of the present disclosure. As shown in FIG. 16, different from the magnetic system of the speaker 1400, the magnetic system 1600 may further include a third magnetic component 1610, a fourth magnetic component 1612, a fifth magnetic component 1614, a third magnetic conductive component 1616, a sixth magnetic component 1624, and a seventh magnetic component 1626. In some embodiments, the third magnetic component 1610, the fourth magnetic component 1612, the fifth magnetic component 1614, the third magnetic conductive component 1616, the sixth magnetic component 1624, and the seventh magnetic component 1626 may be coaxial circular cylinders.

In some embodiments, the upper surface of the second magnetic component 1408 may be mechanically connected to the seventh magnetic component 1626, and the lower surface of the second magnetic component 1408 may be mechanically connected to the third magnetic component 1610. The third magnetic component 1610 may be mechanically connected to the second magnetic conductive component 1406. An upper surface of the seventh magnetic component 1626 may be mechanically connected to the third magnetic conductive component 1616. The fourth magnetic component 1612 may be mechanically connected to the second magnetic conductive component 1406 and the first magnetic component 1402. The sixth magnetic component 1624 may be mechanically connected to the fifth magnetic component 1614, the third magnetic conductive component 1616, and the seventh magnetic component 1626. In some embodiments, the first magnetic component 1402, the first magnetic conductive component 1404, the second magnetic conductive component 1406, the second magnetic component 1408, the third magnetic component 1610, the fourth magnetic component 1612, the fifth magnetic component 1614, the third magnetic conductive component 1616, the sixth magnetic component 1624, and the seventh magnetic component 1626 may form a magnetic loop and a magnetic gap.

In some embodiments, an angle (denoted as A4) between the magnetization direction of the first magnetic component 1402 and the magnetization direction of the sixth magnetic component 1624 may be in a range from 0 degree to 180 degrees. For example, the angle A4 may be in a range from 45 degrees to 135 degrees. As another example, the angle A4 may be not greater than 90 degrees. In some embodiments, the magnetization direction of the first magnetic component 1402 may be parallel to an upward direction (as indicated by an arrow a in FIG. 16) that is perpendicular to the lower surface or the upper surface of the first magnetic component 1402. The magnetization direction of the sixth magnetic component 1624 may be parallel to a direction directed from the outer ring to the inner ring of the sixth magnetic component 1624 (as indicated by an arrow g in FIG. 16 that is on the right side of the first magnetic component 1402 after the magnetization direction of the first magnetic component 1402 rotates 270 degrees clockwise). In some embodiments, the magnetization direction of the sixth magnetic component 1624 may be the same as that of the fourth magnetic component 1612.

In some embodiments, at the position of the sixth magnetic component 1624, an angle (denoted as A5) between the direction of a magnetic field generated by the magnetic system 1600 and the magnetization direction of the sixth magnetic component 1624 may be not greater than 90 degrees. In some embodiments, at the position of the sixth magnetic component 1624, an angle (denoted as A6) between the direction of the magnetic field generated by the first magnetic component 1402 and the magnetization direction of the sixth magnetic component 1624 may be less than or equal to 90 degrees, such as 0 degree, 10 degrees, or 20 degrees.

In some embodiments, an angle (denoted as A7) between the magnetization direction of the first magnetic component 1402 and the magnetization direction of the seventh magnetic component 1626 may be in a range from 0 degree to 180 degrees. For example, the angle A7 may be in a range from 45 degrees to 135 degrees. As another example, the angle A7 may be not greater than 90 degrees. In some embodiments, the magnetization direction of the first magnetic component 1402 may be parallel to an upward direction (as indicated by an arrow a in FIG. 16) that is perpendicular to the lower surface or the upper surface of the first magnetic component 1402. The magnetization direction of the seventh magnetic component 1626 may be parallel to a direction directed from a lower surface to an upper surface of the seventh magnetic component 1626 (as indicated by an arrow fin FIG. 16 that is on the right side of the first magnetic component 1402 after the magnetization direction of the first magnetic component 1402 rotates 360 degrees clockwise). In some embodiments, the magnetization direction of the seventh magnetic component 1626 may be opposite to that of the third magnetic component 1610.

In some embodiments, at the seventh magnetic component 1626, an angle (denoted as A8) between the direction of the magnetic field generated by the magnetic system 1600 and the magnetization direction of the seventh magnetic component 1626 may be not greater than 90 degrees. In some embodiments, at the position of the seventh magnetic component 1626, an angle (denoted as A9) between the direction of the magnetic field generated by the first magnetic component 1402 and the magnetization direction of the seventh magnetic component 1626 may be less than or equal to 90 degrees, such as 0 degree, 10 degrees, or 20 degrees.

In the magnetic system 1600, the third magnetic conductive component 1616 may close the magnetic field loops generated by the magnetic system 1600, so that more magnetic induction lines may be concentrated in the magnetic gap. This may suppress the magnetic leakage, increase the magnetic induction intensity within the magnetic gap, and improve the sensitivity of the speaker.

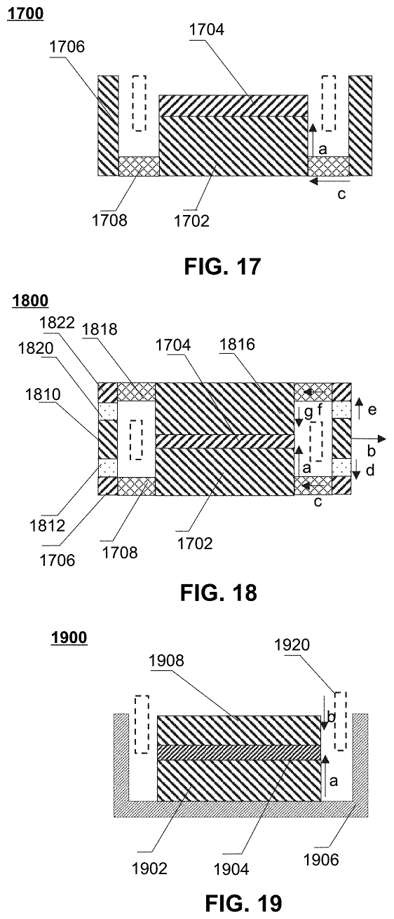

FIG. 17 is a schematic diagram illustrating a longitudinal sectional view of an exemplary magnetic system 1700 according to some embodiments of the present disclosure. As shown in FIG. 17, the magnetic system 1700 may include a first magnetic component 1702, a first magnetic conductive component 1704, a first magnetic field changing component 1706, and a second magnetic component 1708.

In some embodiments, an upper surface of the first magnetic component 1702 may be mechanically connected to the lower surface of the first magnetic conductive component 1704. The second magnetic component 1708 may be mechanically connected to the first magnetic component 1702 and the first magnetic field changing component 1706. Two or more of the first magnetic component 1702, the first magnetic conductive component 1704, the first magnetic field changing component 1706, and/or the second magnetic component 1708 may be connected to each other via a mechanical connection as described elsewhere in this disclosure (e.g., FIG. 14 and the relevant descriptions). In some embodiments, the first magnetic component 1702, the first magnetic conductive component 1704, the first magnetic field changing component 1706, and/or the second magnetic component 1708 may form a magnetic field loop and a magnetic gap.

In some embodiments, the magnetic system 1700 may generate a first total magnetic field, and the first magnetic component 1702 may generate a second magnetic field. The magnetic field intensity of the first total magnetic field within the magnetic gap may be greater than that of the second magnetic field within the magnetic gap. In some embodiments, the second magnetic component 1708 may generate a third magnetic field, and the third magnetic field may increase the intensity of the magnetic field of the second magnetic field at the magnetic gap.

In some embodiments, an angle (denoted as A10) between the magnetization direction of the first magnetic component 1702 and the magnetization direction of the second magnetic component 1708 may be in a range from 0 degree to 180 degrees. For example, the angle A10 may be in a range from 45 degrees to 135 degrees. As another example, the angle A10 may be not greater than 90 degrees.

In some embodiments, at the position of the second magnetic component 1708, an angle (denoted as A11) between the direction of the first total magnetic field and the magnetization direction of the second magnetic component 1708 may be not greater than 90 degrees. In some embodiments, at the position of the second magnetic component 1708, an angle (denoted as Al2) between the direction of the second magnetic field generated by the first magnetic component 1702 and the magnetization direction of the second magnetic component 1708 may be less than or equal to 90 degrees, such as 0 degree, 10 degrees, and 20 degrees. In some embodiments, the magnetization direction of the first magnetic component 1702 may be parallel to an upward direction (as indicated by an arrow a in FIG. 17) that is perpendicular to the lower surface or the upper surface of the first magnetic component 1702. The magnetization direction of the second magnetic component 1708 may be parallel to a direction directed from the outer ring to the inner ring of the second magnetic component 1708 (as indicated by an arrow c in FIG. 17 that is on the right side of the first magnetic component 1702 after the magnetization direction of the first magnetic component 1702 rotates 90 degrees clockwise). Compared with a magnetic system with a single magnetic component, the first magnetic field changing component 1706 in the magnetic system 1700 may increase the total magnetic induction lines within the magnetic gap, thereby increasing the magnetic induction intensity within the magnetic gap. In addition, due to the first magnetic field changing component 1706, the originally scattered magnetic induction lines may be converged to the position of the magnetic gap, which may further increase the magnetic induction intensity within the magnetic gap.

FIG. 18 is a schematic diagram illustrating a longitudinal sectional view of an exemplary magnetic system 1800 according to some embodiments of the present disclosure. As shown in FIG. 18, in some embodiments, the magnetic system 1800 may include a first magnetic component 1702, a first magnetic conductive component 1704, a first magnetic field changing component 1706, a second magnetic component 1708, a third magnetic component 1810, a fourth magnetic component 1812, a fifth magnetic component 1816, a sixth magnetic component 1818, a seventh magnetic component 1820, and a second ring component 1822. In some embodiments, the first magnetic field changing component 1706 and/or the second ring component 1822 may include a ring-shaped magnetic component or a ring-shaped magnetic conductive component.

A ring-shaped magnetic component may include any one or more magnetic materials as described elsewhere in this disclosure (e.g., FIG. 14 and the relevant descriptions). A ring-shaped magnetic conductive component may include any one or more magnetically conductive materials described in the present disclosure (e.g., FIG. 14 and the relevant descriptions).

In some embodiments, the sixth magnetic component 1818 may be mechanically connected to the fifth magnetic component 1816 and the second ring component 1822. The seventh magnetic component 1820 may be mechanically connected to the third magnetic component 1810 and the second ring component 1822. In some embodiments, one or more of the first magnetic component 1702, the fifth magnetic component 1816, the second magnetic component 1708, the third magnetic component 1810, the fourth magnetic component 1812, the sixth magnetic component 1818, the seventh magnetic component 1820, the first magnetic conductive component 1704, the first magnetic field changing component 1706, and the second ring component 1822 may form a magnetic field loop.

In some embodiments, an angle (denoted as A13) between the magnetization direction of the first magnetic component 1702 and the magnetization direction of the sixth magnetic component 1818 may be in a range from 0 degree and 180 degrees. For example, the angle A13 may be in a range from 45 degrees to 135 degrees. As another example, the angle A13 may be not greater than 90 degrees. In some embodiments, the magnetization direction of the first magnetic component 1702 may be parallel to an upward direction (as indicated by an arrow a in FIG. 18) that is perpendicular to the lower surface or the upper surface of the first magnetic component 1702. The magnetization direction of the sixth magnetic component 1818 may be parallel to a direction directed from the outer ring to the inner ring of the sixth magnetic component 1818 (as indicated by an arrow fin FIG. 18 that is on the right side of the first magnetic component 1702 after the magnetization direction of the first magnetic component 1402 rotates 270 degrees clockwise). In some embodiments, the magnetization direction of the sixth magnetic component 1818 may be the same as that of the second magnetic component 1708. The magnetization direction of the seventh magnetic component 1820 may be parallel to a direction directed from the lower surface to the upper surface of the seventh magnetic component 1820 (as indicated by an arrow e in FIG. 18 that is on the right side of the first magnetic component 1702 after the magnetization direction of the first magnetic component 1702 rotates 90 degrees clockwise). In some embodiments, the magnetization direction of the seventh magnetic component 1820 may be the same as that of the fourth magnetic component 1812.

In some embodiments, at the position of the sixth magnetic component 1818, an angle (denoted as A14) between the direction of the magnetic field generated by the magnetic system 1800 and the magnetization direction of the sixth magnetic component 1818 may be not greater than 90 degrees. In some embodiments, at the position of the sixth magnetic component 1818, an angle (denoted as A15) between the direction of the magnetic field generated by the first magnetic component 1702 and the magnetization direction of the sixth magnetic component 1818 may be less than or equal to 90 degrees, such as 0 degree, 10 degrees, and 20 degrees.

In some embodiments, an angle (denoted as A16) between the magnetization direction of the first magnetic component 1702 and the magnetization direction of the seventh magnetic component 1820 may be in a range from 0 degree and 180 degrees. For example, the angle A16 may be in a range from 45 degrees to 135 degrees. As another example, the angle A16 may be not greater than 90 degrees.

In some embodiments, at the position of the seventh magnetic component 1820, an angle (denoted as A17) between the direction of the magnetic field generated by the magnetic system 1800 and the magnetization direction of the seventh magnetic component 1820 may be not greater than 90 degrees. In some embodiments, at the position of the seventh magnetic component 1820, an angle (denoted as A18) between the direction of the magnetic field generated by the first magnetic component 1702 and the magnetization direction of the seventh magnetic component 1820 may be less than or equal to 90 degrees, such as 0 degree, 10 degrees, and 20 degrees.

In some embodiments, the first magnetic field changing component 1706 may be a ring-shaped magnetic component. The magnetization direction of the first magnetic field changing component 1706 may be the same as that of the second magnetic component 1708 or the fourth magnetic component 1812. For example, on the right side of the first magnetic component 1702, the magnetization direction of the first magnetic field changing component 1706 may be parallel to a direction directed from the outer ring to the inner ring of the first magnetic field changing component 1706. In some embodiments, the second ring component 1822 may be a ring-shaped magnetic component. The magnetization direction of the second ring component 1822 may be the same as that of the sixth magnetic component 1818 or the seventh magnetic component 1820. For example, on the right side of the first magnetic component 1702, the magnetization direction of the second ring component 1822 may be parallel to a direction directed from the outer ring to the inner ring of the second ring component 1822. In the magnetic system 1800, the plurality of magnetic components may increase the total magnetic induction lines, and different magnetic components may interact, which may suppress the leakage of the magnetic induction lines, increase the magnetic induction intensity within the magnetic gap, and improve the sensitivity of the speaker.

In some embodiments, the magnetic system 1800 may further include a magnetic conductive cover. The magnetic conductive cover may include one or more magnetic conductive materials (e.g., low carbon steel, silicon steel sheet, silicon steel sheet, ferrite, etc.) described in the present disclosure. For example, the magnetic conductive cover may be mechanically connected to the first magnetic component 1702, the first magnetic field changing component 1706, the second magnetic component 1708, the third magnetic component 1810, the fourth magnetic component 1812, the fifth magnetic component 1816, the sixth magnetic component 1818, the seventh magnetic component 1820, and the second ring component 1822. In some embodiments, the magnetic conductive cover may include at least one bottom plate and a side wall. The side wall may have a ring structure. The at least one bottom plate and the side wall may form an integral assembly. Alternatively, the at least one bottom plate may be mechanically connected to the side wall via one or more mechanical connections as described elsewhere in the present disclosure. For example, the magnetic conductive cover may include a first base plate, a second base plate, and a side wall. The first bottom plate and the side wall may form an integral assembly, and the second bottom plate may be mechanically connected to the side wall via one or more mechanical connections described elsewhere in the present disclosure.

In the magnetic system 1700, the magnetic conductive cover may close the magnetic field loops generated by the magnetic system 1700, so that more magnetic induction lines may be concentrated in the magnetic gap in the magnetic system 1700. This may suppress the magnetic leakage, increase the magnetic induction intensity at the magnetic gap, and improve the sensitivity of the speaker.

In some embodiments, the magnetic system 1700 may further include one or more electric conductive components (e.g., a first electric conductive component, a second electric conductive component, and a third electric conductive component). The one or more electric conductive components may be similar to the first electric conductive component 1448, the second electric conductive component 1450, and the third electric conductive component 1452 as described in connection with FIG. 15.

FIG. 19 is a schematic diagram illustrating a longitudinal sectional view of an exemplary magnetic system 1900 according to some embodiments of the present disclosure. As shown in FIG. 19, the magnetic system 1900 may include a first magnetic component 1902, a first magnetic conductive component 1904, a second magnetic conductive component 1906, and a second magnetic component 1908.

In some embodiments, the first magnetic component 1902 and/or the second magnetic component 1908 may include one or more of the magnets described in the present disclosure. In some embodiments, the first magnetic component 1902 may include a first magnet, and the second magnetic component 1908 may include a second magnet. The first magnet and the second magnet may be the same or different. The first magnetic conductive component 1904 and/or the second magnetic conductive component 1906 may include one or more magnetic conductive materials described in the present disclosure. The first magnetic conductive component 1904 and/or the second magnetic conductive component 1906 may be manufactured by one or more processing methods described in the present disclosure. In some embodiments, the first magnetic component 1902, the first magnetic conductive component 1904, and/or the second magnetic component 1908 may have an axisymmetric structure. For example, each of the first magnetic component 1902, the first magnetic conductive component 1904, and/or the second magnetic component 1908 may be a cylinder. In some embodiments, the first magnetic component 1902, the first magnetic conductive component 1904, and/or the second magnetic component 1908 may be coaxial cylinders containing the same or different diameters. The thickness of the first magnetic component 1902 may be greater than or equal to that of the second magnetic component 1908. In some embodiments, the second magnetic conductive component 1906 may have a groove-shaped structure. In some embodiments, the groove-shaped structure may include a U-shaped cross section. The groove-shaped second magnetic conductive component 1906 may include a bottom plate and a sidewall. In some embodiments, the bottom plate and the side wall may form an integral assembly. For example, the side wall may be formed by extending the bottom plate in a direction perpendicular to the bottom plate. In some embodiments, the bottom plate may be mechanically connected to the side wall via a mechanical connection as described elsewhere in this disclosure (e.g., FIG. 14 and the relevant descriptions). The second magnetic component 1908 may have a shape of a ring or a sheet. The shape of the second magnetic component 1908 may be similar to that of the second magnetic component 1408 as described in connection with FIG. 15. In some embodiments, the second magnetic component 1908 may be coaxial with the first magnetic component 1902 and/or the first magnetic conductive component 1904.

In some embodiments, an upper surface of the first magnetic component 1902 may be mechanically connected to a lower surface of the first magnetic conductive component 1904. A lower surface of the first magnetic component 1902 may be mechanically connected to the bottom plate of the second magnetic conductive component 1906. A lower surface of the second magnetic component 1908 may be mechanically connected to an upper surface of the first magnetic conductive component 1904. Two or more of the first magnetic component 1902, the first magnetic conductive component 1904, the second magnetic conductive component 1906, and/or the second magnetic component 1908 may be connected to each other via a mechanical connection as described elsewhere in this disclosure (e.g., FIG. 14 and the relevant descriptions).

In some embodiments, a magnetic gap may be formed between the first magnetic component 1902, the first magnetic conductive component 1904, the second magnetic component 1908 and a sidewall of the second magnetic conductive component 1906. A voice coil 1920 may be disposed in a magnetic gap. In some embodiments, the first magnetic component 1902, the first magnetic conductive component 1904, the second magnetic conductive component 1906, and the second magnetic component 1908 may form a magnetic field loop. In some embodiments, the magnetic system 1900 may generate a first total magnetic field, and the first magnetic component 1902 may generate a second magnetic field. The first total magnetic field may be formed by all magnetic fields generated by all components of the magnetic system 1900 (e.g., the first magnetic component 1902, the first magnetic conductive component 1904, the second magnetic conductive component 1906, and the second magnetic component 1908). The intensity of the magnetic field (or referred to as a magnetic induction intensity or a magnetic induction lines density) within the magnetic gap of the first total magnetic field may be greater than the intensity of the magnetic field within the magnetic gap of the second magnetic field. In some embodiments, the second magnetic component 1908 may generate a third magnetic field, and the third magnetic field may increase the intensity of the magnetic field of the second magnetic field within the magnetic gap.

In some embodiments, an angle (denoted as A19) between the magnetization direction of the second magnetic component 1908 and the magnetization direction of the first magnetic component 1902 may be in a range from 90 degrees and 180 degrees. For example, the angle A10 may be in a range from 150 degrees to 180 degrees. Merely by way of example, the magnetization direction of the second magnetic component 1908 (as indicated by an arrow b in FIG. 19) may be opposite to the magnetization direction of the first magnetic component 1902 (as indicated by an arrow a in FIG. 19).

Compared with the magnetic system with a single magnetic component, the magnetic system 1900 includes a second magnetic component 1908. The second magnetic component 1908 may have a magnetization direction opposite to that of the first magnetic component 1902, which may suppress the magnetic leakage of the first magnetic component 1902 in its magnetization direction, so that more magnetic induction lines generated by the first magnetic component 1902 may be concentrated in the magnetic gap, thereby increasing the magnetic induction intensity within the magnetic gap.

It should be noted that the above description regarding the magnetic systems is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, a magnetic system may include one or more additional components and/or one or more components of the speaker described above may be omitted. Additionally or alternatively, two or more components of a magnetic system may be integrated into a single component. A component of the magnetic system may be implemented on two or more sub-components.

The embodiments described above are merely implements of the present disclosure, and the descriptions may be specific and detailed, but these descriptions may not limit the present disclosure. It should be noted that those skilled in the art, without deviating from concepts of the bone conduction speaker, may make various modifications and changes to, for example, the sound transfer approaches described in the specification, but these combinations and modifications are still within the scope of the present disclosure.

What is claimed is:

1. A bone conduction speaker, comprising:
a vibration device comprising a vibration conductive plate and a vibration board, wherein
the vibration conductive plate is physically connected with the vibration board, vibrations generated by the vibration conductive plate and the vibration board have at least two resonance peaks, frequencies of the at least two resonance peaks being catchable with human ears, and sounds are generated by the vibrations transferred through a human bone; and
a magnetic system for generating a first magnetic field, wherein the magnetic system includes:
a first magnetic component for generating a second magnetic field; and
at least one second magnetic component surrounding the first magnetic component, wherein a magnetic gap is formed between the first magnetic component and the at least one second magnetic component, and a magnetic field intensity of the first magnetic field in the magnetic gap is greater than a magnetic field intensity of the second magnetic field in the magnetic gap.

2. The bone conduction speaker according to claim 1, wherein the magnetic system further comprises:
a first magnetic conductive component mechanically connected to a first surface of the first magnetic component.

3. The bone conduction speaker according to claim 2, wherein the magnetic system further comprises:
a second magnetic conductive component mechanically connected to a second surface of the first magnetic component, the second surface being opposite to the first surface of the first magnetic component; and
at least one third magnetic component, wherein the at least one third magnetic component is mechanically connected to each of the second magnetic conductive component and the at least one second magnetic component.

4. The bone conduction speaker according to claim 3, wherein the magnetic system further comprises at least one fourth magnetic component placed within the magnetic gap and mechanically connected to each of the first magnetic component and the second magnetic conductive component.

5. The bone conduction speaker according to claim 3, wherein the magnetic system further comprises at least one electric conductive component mechanically connected to at least one of the first magnetic component, the first magnetic conductive component, or the second magnetic conductive component.

6. The bone conduction speaker according to claim 2, wherein the magnetic system further comprises at least one of fifth magnetic component mechanically connected to the first magnetic conductive component, wherein the at least one fifth magnetic component and the first magnetic component are located at opposite sides of the first magnetic conductive component.

7. The bone conduction speaker according to claim 6, wherein the magnetic system further comprises a third magnetic conductive component for suppressing a magnetic field leakage of the first magnetic field, wherein
the third magnetic conductive component is mechanically connected to the fifth magnetic component, and
the third magnetic conductive component and the first magnetic conductive component are located at opposite sides of the fifth magnetic component.

8. The bone conduction speaker according to claim 1, wherein the vibration conductive plate includes a first torus and at least two first rods, the at least two first rods converging to a center of the first torus.

9. The bone conduction speaker according to claim 8, wherein the vibration board includes a second torus and at least two second rods, the at least two second rods converging to a center of the second torus.

10. The bone conduction speaker according to claim 9, wherein the first torus is fixed on at least a portion of the magnetic system.

11. The bone conduction speaker according to claim 10, further comprising a voice coil, wherein the voice coil is driven by the magnetic system and fixed on the second torus.

12. The bone conduction speaker according to claim 11, wherein the at least two first rods are staggered with the at least two second rods.

13. The bone conduction speaker according to claim 12, wherein a staggered angle between one of the at least two first rods and one of the at least two second rods is 60 degrees.

14. The bone conduction speaker according to claim 1, wherein the vibration conductive plate is made of stainless steels and has a thickness in a range of 0.1 to 0.2 mm.

15. The bone conduction speaker according to claim 1, wherein a lower resonance peak of the at least two resonance peaks is equal to or lower than 900 Hz.

16. The bone conduction speaker according to claim 15, wherein a higher resonance peak of the at least two resonance peaks is equal to or lower than 9500 Hz.

17. A method, comprising:
providing a bone conduction speaker, comprising:
a vibration device having a vibration conductive plate and a vibration board, wherein
the vibration conductive plate is physically connected with the vibration board, vibrations generated by the vibration conductive plate and the vibration board have at least two resonance peaks, frequencies of the at least two resonance peaks being catchable with human ears, and sounds are generated by the vibrations transferred through a human bone; and
a magnetic system for generating a first magnetic field, wherein the magnetic system includes:
a first magnetic component for generating a second magnetic field; and
at least one second magnetic component surrounding the first magnetic component, wherein a magnetic gap is formed between the first magnetic component and the at least one second magnetic component, and a magnetic field intensity of the first magnetic field in the magnetic gap is greater than a magnetic field intensity of the second magnetic field in the magnetic gap.

18. The method according to claim 17, wherein the magnetic system further comprises: a first magnetic conductive component mechanically connected to a first surface of the first magnetic component.

19. The method according to claim 17, wherein a lower resonance peak of the at least two resonance peaks is equal to or lower than 900 Hz.

20. The method according to claim 19, wherein a higher resonance peak of the at least two resonance peaks is equal to or lower than 9500 Hz.
